(19) United States
(12) Patent Application Publication
(10) Pub. No.: US 2013/0343465 A1
(43) Pub. Date: Dec. 26, 2013

(54) HEADER PARAMETER SETS FOR VIDEO CODING

(71) Applicant: Qualcomm Incorporated, San Diego, CA (US)

(72) Inventors: Ying CHEN, San Diego, CA (US); Ye-Kui WANG, San Diego, CA (US)

(21) Appl. No.: 13/926,387

(22) Filed: Jun. 25, 2013

Related U.S. Application Data
(60) Provisional application No. 61/664,488, filed on Jun. 26, 2012.
(60) Provisional application No. 61/665,713, filed on Jun. 28, 2012.
(60) Provisional application No. 61/751,180, filed on Jan. 10, 2013.

(51) Int. Cl. H04N 7/26

(52) U.S. Cl. CPC H04N 19/004
USPC 375/240.24

(57) ABSTRACT

An example method of decoding video data includes determining a header parameter set that includes one or more syntax elements specified individually by each of one or more slice headers, the header parameter set being associated with a header parameter set identifier (HPS ID), and determining one or more slice headers that reference the header parameter set to inherit at least one of the syntax elements included in the header parameter set, where the slice headers are each associated with a slice of the encoded video data, and where the slice headers each reference the header parameter set using the HPS ID.

This application claims the benefit of:

U.S. Provisional Application No. 61/664,488, filed Jun. 26, 2012;

U.S. Provisional Application No. 61/665,713, filed Jun. 28, 2012; and

U.S. Provisional Application No. 61/751,180, filed Jan. 10, 2013, the entire contents of each of which are incorporated herein by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for coding slice headers of a picture, using header parameter sets (HPSs). In specific examples, a video coding device may use the HPSs described herein to efficiently code and/or signal one or both slice-level parameters included in one or more slice headers. For instance, the video coding device may determine that a single HPS includes data that is common to multiple slice headers, and code the slice headers by inheriting pertinent data from one or more HPSs referenced in each such slice header or by inheriting pertinent data for a slice from one or more HPSs.

In one example, a method of decoding video data includes determining a header parameter set that includes one or more syntax elements specified individually by each of one or more slice headers, the header parameter set being associated with a header parameter set identifier (HPS ID), and determining one or more slice headers that reference the header parameter set to inherit at least one of the syntax elements included in the header parameter set, where the slice headers are each associated with a slice of the encoded video data, and where the slice headers each reference the header parameter set using the HPS ID.

In another example, a method of encoding video data includes generating a header parameter set that includes one or more syntax elements specified individually by each of one or more slice headers, the header parameter set being associated with a header parameter set identifier (HPS ID), and generating one or more slice headers to reference the header parameter set to inherit at least one of the syntax elements included in the header parameter set, where the slice headers are each associated with a slice of the encoded video data, and where the slice headers each reference the header parameter set using the HPS ID.

In another example, a device for coding video data includes a video coder configured to determine a header parameter set that includes one or more syntax elements specified individually by each of one or more slice headers, the header parameter set being associated with a header parameter set identifier (HPS ID), and determine one or more slice headers that reference the header parameter set to inherit at least one of the syntax elements included in the header parameter set, where the slice headers are each associated with a slice of encoded video data, and where the slice headers each reference the header parameter set using the HPS ID.

In another example, a device for coding video data includes means for determining a header parameter set that includes one or more syntax elements specified individually by each of one or more slice headers, the header parameter set being associated with a header parameter set identifier (HPS ID), and means for determining one or more slice headers that reference the header parameter set to inherit at least one of the syntax elements included in the header parameter set, where the slice headers are each associated with a slice of the encoded video data, and where the slice headers each reference the header parameter set using the HPS ID.

In another example, a computer-readable storage medium has stored thereon instructions that, when executed, cause a programmable processor of a computing device to determine a header parameter set that includes one or more syntax elements specified individually by each of one or more slice headers, the header parameter set being associated with a header parameter set identifier (HPS ID), and determine one or more slice headers that reference the header parameter set to inherit at least one of the syntax elements included in the header parameter set, where the slice headers are each associated with a slice of encoded video data, and where the slice headers each reference the header parameter set using the HPS ID.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIG. 4 is a conceptual diagram illustrating an example header parameter set (HPS) model incorporating inter-layer dependency, in accordance with one or more aspects of this disclosure.

FIG. 5 is a flowchart illustrating an example process that a video decoder and/or components thereof may perform to decode encoded video data, in accordance with one or more aspects of this disclosure.

FIG. 6 is a flowchart illustrating an example process that video encoder and/or components thereof may perform to encode video data, in accordance with one or more aspects of this disclosure.

### DETAILED DESCRIPTION

In general, techniques of this disclosure are directed to header parameter sets (HPSs). In specific examples, a video coding device may use the HPSs described herein, in conjunction with network abstraction layer (NAL) units, to efficiently code and/or signal one or both of picture-level and slice-level parameters. As used herein, a video coding device may generally refer to any device that performs one or both of video encoding and video decoding. Additionally, the techniques described in this disclosure may be applicable to one or more video coding standards with which a video coding device may comply. Examples of such video coding standards may include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions, the High Efficiency Video Coding (HEVC) standard presently under development, and extensions of such standards.

According to HEVC, a video coding device may use one or more of video, sequence, picture and adaptation parameter set (VPS, SPS, PPS, and APS) mechanisms to decouple the transmission of infrequently changing information from the transmission of coded block data. For instance, in some implementations, the video coding device may convey one or more of the VPS, SPS, PPS, and APS “out-of-band.” In other words, according to such implementations, the video coding device may not signal one or more of the VPS, SPS, PPS, and APS together with NAL units that include encoded video data. Additionally, out-of-band transmission is often more reliable (e.g., error-resistant or error-resilient) than in-band transmission.

Additionally, the video coding device may code each individual picture on a slice-by-slice basis, such that different slices of a single picture may be of equal or different lengths (e.g., expressed as respective numbers of blocks in each slice). In turn, the video coding device may associate each slice with a corresponding slice header. Similarly to the various parameter sets described above, a slice header may include syntax elements, such as one or more parameters, that apply to all blocks of the corresponding slice. In turn, the video coding device may determine that a NAL unit includes data corresponding to one or more slices of a picture, separated by slice header information included in the NAL unit.

According to the current HEVC working draft, each slice header includes a PPS ID and, optionally, an APS ID. In other words, each slice header may reference the PPS for the picture to which the corresponding slice belongs. Additionally, each slice header may, in some scenarios, reference the APS for the picture to which the corresponding slice belongs. Earlier video coding standards included one or more techniques by which a video coding device may determine various parameters that are common across the picture-level. As one example, according to the audio-visual coding standard for the mobile multimedia application (AVS-M) standard, a picture header NAL unit included those picture-level parameters that must be the same for all slices of a picture, but are not included in the PPS corresponding to the picture.

Existing solutions, such as the solution of the AVS-M standard described above, may introduce one or more potential problems. For instance, in the context of HEVC, the slice header may include several syntax elements, most of which are the same with respect to all slices in a picture. Existing solutions may not enable a video coding device to conserve computing resources and bandwidth by inheriting syntax elements that are common to all slices of a picture, while also accommodating any syntax elements that vary across two or more slices of the picture. Thus, a video coding device may function more efficiently by implementing techniques by which the video coding device is not required to repeatedly send and/or receive parameter sets for each slice, where the parameter sets, or portions thereof, are common to all slices of the picture. Additionally, the video coding device may implement the techniques to also allow for one or more parameters that change from one slice of the picture to another.

In accordance with one or more techniques of this disclosure, a video coding device may utilize header parameter sets to enable efficient and error-resilient signaling of picture-level and slice level information shared by multiple NAL units. As used herein, the term “layer” may refer to a layer in the context of scalable coding, a view in the context of multiview coding, or a combination of a view and an indication of whether the current NAL unit belongs to texture or depth in three-dimensional video (3DV) coding. Additionally, as used herein, “inter-layer prediction” may refer to inter-view prediction, e.g., a prediction between a texture component and a depth component, and, in some instances, virtual or synthesized layer/view/depth components. Various implementations of the techniques are described in more detail below, with respect to the accompanying drawings.

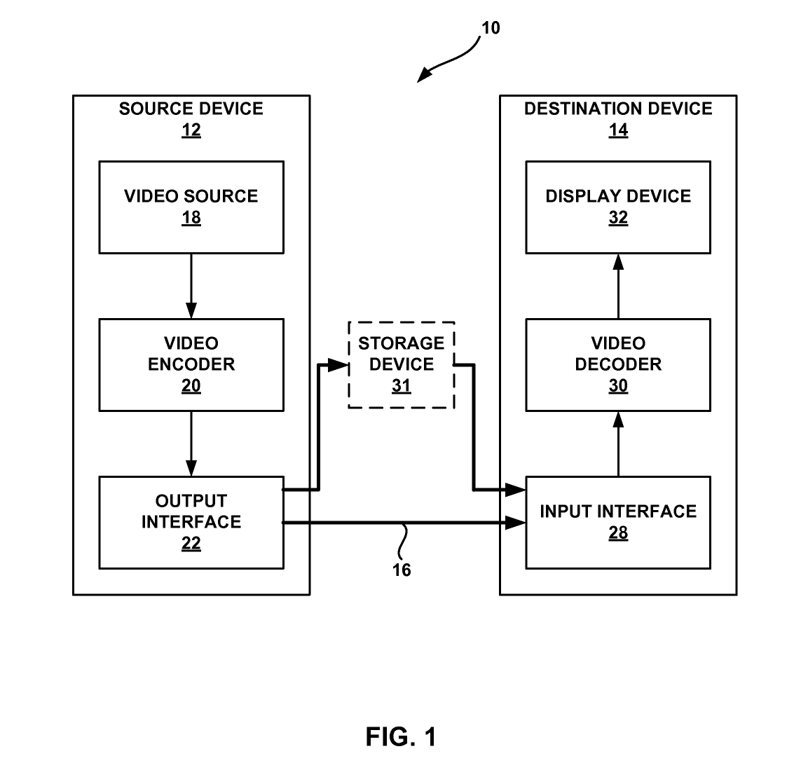

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 31. Similarly, encoded data may be accessed from storage device 31 by input interface. Storage device 31 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 31 may correspond to a file server or another intermediate storage device that may hold the encoded video generated by source device 12. Destination device 14 may access stored video data from storage device 31 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 31 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 31 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 31, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU may include a luma coding block and two chroma coding blocks. The CU may have associated prediction units (PUs) and transform units (TUs). Each of the PUs may include one luma prediction block and two chroma prediction blocks, and each of the TUs may include one luma transform block and two chroma transform blocks. Each of the coding blocks may be partitioned into one or more prediction blocks that comprise blocks to samples to which the same prediction applies. Each of the coding blocks may also be partitioned in one or more transform blocks that comprise blocks of sample on which the same transform is applied.

A size of the CU generally corresponds to a size of the coding node and is typically square in shape. The size of the CU may range from 8×8 pixels up to the size of the treeblock with a maximum of 64×64 pixels or greater. Each CU may define one or more PUs and one or more TUs. Syntax data included in a CU may describe, for example, partitioning of the coding block into one or more prediction blocks. Partitioning modes may differ between whether the CU is skip or direct mode encoded, intra-prediction mode encoded, or inter-prediction mode encoded. Prediction blocks may be partitioned to be square or non-square in shape. Syntax data included in a CU may also describe, for example, partitioning of the coding block into one or more transform blocks according to a quadtree. Transform blocks may be partitioned to be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may represent the TUs. Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more TUs. Following prediction, video encoder 20 may calculate residual values from the video block identified by the coding node in accordance with the PU. The coding node is then updated to reference the residual values rather than the original video block. The residual values comprise pixel difference values that may be transformed into transform coefficients, quantized, and scanned using the transforms and other transform information specified in the TUs to produce serialized transform coefficients for entropy coding. The coding node may once again be updated to refer to these serialized transform coefficients. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data to which the transforms specified by TUs of the CU are applied. The residual data may correspond to pixel differences between pixels of the unencoded picture and prediction values corresponding to the CUs. Video encoder 20 may form the residual data for the CU, and then transform the residual data to produce transform coefficients.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

One or both of video encoder 20 and video decoder 30 may implement techniques of this disclosure to utilize a header parameter set (HPS) to enable efficient and reliable encoding, signaling, and decoding of the slice headers of a picture. In one implementation of the techniques, video encoder 20 may generate an HPS that includes one or more syntax elements that would otherwise be specified individually in each of one or more slice headers for an encoded picture. As one example, video encoder 20 may generate the HPS such that the HPS includes one or more syntax elements that are common to all slice headers of the encoded picture. As another example, video encoder 20 may generate the HPS such that the HPS includes one or more syntax elements that are common to two or more slice headers of the encoded picture, but not common to all slice headers of the encoded picture.

Additionally, video encoder 20 may generate one or more slice headers of the encoded picture to reference the HPS. More specifically, by generating the slice headers to reference the HPS, video encoder 20 may incorporate at least one of the syntax elements of the HPS into the particular slice headers that reference the HPS. In other words, video encoder 20 may inherit the values of portions of such slice headers from the HPS into the particular slice headers that reference the HPS. By generating multiple slice headers to inherit syntax elements of the same values from the HPS, video encoder 20 may implement the techniques of this disclosure to mitigate, or potentially eliminate, duplicate generation of shared syntax elements for multiple slice headers. Instead, by implementing the techniques, video encoder 20 may generate the shared syntax elements once, with respect to generating the HPS, and generate multiple slice headers to inherit the shared syntax elements from the HPS, thereby conserving computing resources and bandwidth/storage capacity required for signaling.

In this example, video decoder 30 may implement corresponding techniques to more efficiently and robustly decode the encoded picture signaled by video encoder 20. For instance, in decoding the slice headers of an encoded picture received as part of an encoded bitstream, video decoder 30 may determine that an HPS includes one or more syntax elements specified individually by the one or more slice headers. More specifically, video decoder 30 may determine that one or more slice headers of the encoded picture reference an HPS that is signaled as part of the encoded bitstream. Based on the determination that the particular slice headers reference the HPS, video decoder 30 may decode the particular slice headers by inheriting certain syntax elements from the HPS into the particular slice headers that reference the HPS. By inheriting syntax elements from the HPS into multiple slice headers of the encoded picture, video decoder 30 may implement the techniques of this disclosure to mitigate, or potentially eliminate, duplicate decoding of shared syntax elements for multiple slice headers. Instead, by implementing the techniques, video decoder 30 may decode the shared syntax elements once, with respect to decoding the HPS, and decode multiple slice headers to inherit the shared syntax elements from the HPS, thereby conserving computing resources that video decoder 30 may otherwise expend in decoding the encoded picture.

According to one implementation of the techniques described herein, one or both of video encoder 20 and video decoder 30 may determine that the HPS is included in a different NAL unit than the encoded data corresponding to the picture. For instance, video encoder 20 may encapsulate the HPS in a particular NAL unit, and encapsulate the encoded picture (e.g., including the corresponding slice headers and encoded blocks arranged in slices) in a different NAL unit. Additionally, video encoder 20 may signal the NAL units separately, i.e., video encoder 20 may signal the encoded HPS and the encoded picture in separate NAL units.

Additionally, according to this implementation, video encoder 20 may associate the NAL unit that includes the HPS with one or more NAL units that include encoded slices (and corresponding slice headers) of the encoded picture. More specifically, video encoder 20 may generate one or more video coding layer (VCL) NAL units that encapsulate the slices and corresponding slice headers of the encoded picture. Conversely, video encoder 20 may generate a non-VCL NAL unit that encapsulates the HPS. Video encoder 20 may generate the respective NAL units such that, in combination, the non-VCL NAL unit and the one or more VCL NAL units form an entire access unit (AU) associated with the encoded picture. As used herein, an AU may include all video data and parameter data that represent a time instance of the video (e.g., an encoded picture in combination with all applicable parameter data).

In this implementation, video decoder 30 may receive separate NAL units, with one NAL unit encapsulating the HPS, and one or more different NAL units that encapsulate the encoded slices and corresponding slice headers of the picture. As described with respect to video encoder 20, video decoder 30 may determine that a received non-VCL unit encapsulates the encoded HPS, while one or more VCL NAL units encapsulate the encoded slices and slice headers of the picture. More specifically, video decoder 30 may determine that the non-VCL NAL unit encapsulating the HPS and the one or more VCL units encapsulating the encoded slices and slice headers combine to form an AU corresponding to the encoded picture.

In some examples according to this implementation, one or both of video encoder 20 and video decoder 30 may determine that the non-VCL NAL unit encapsulating the HPS is associated with VCL NAL units of the same AU, but not with VCL NAL units of another AU. In other words, one or both of video encoder 20 and video decoder 30 may determine, in these scenarios, that a particular HPS only includes syntax elements that may be inherited by slice headers of a single encoded picture.

According to some implementations of the techniques described herein, video encoder 20 and video decoder 30 may determine that a single AU includes multiple HPSs. For instance, when encoding a picture according to two-dimensional (2D) video coding, video encoder 20 may generate each HPS to include a unique identifier (ID). In turn, video encoder 20 may generate a slice header of the encoded picture, to reference multiple HPSs of the corresponding AU. More specifically, video encoder 20 may generate the slice header to reference each of the multiple HPSs using the respective ID of each HPS.

By generating a slice header to reference multiple HPSs, video encoder 20 may inherit particular portions of each referenced HPS in generating the slice header. In this manner, video encoder 20 may further reduce duplication of data generation with respect to a slice header. More specifically, by inheriting pertinent parameters from multiple HPSs, video encoder 20 may mitigate the need to generate and encode multiple parameters of the slice header, by expanding the available inheritance sources to include multiple HPSs of the AU. According to these implementations, video encoder 20 may generate each HPS to include one or more flags. More specifically, video encoder 20 may set a value of each flag to indicate whether the particular HPS includes specific data, such as specific parameters. In this manner, video encoder 20 may implement techniques of this disclosure such that each HPS need not include a complete set of parameters available for inheritance into slice headers of the AU.

Similarly, according to these implementations, video decoder 30 may determine, based on a received encoded bitstream, that an AU includes multiple HPSs, each associated with a unique ID. Additionally, video decoder 30 may determine that a slice header included in the AU references two or more of the multiple HPSs, using the respective IDs of the HPSs. Additionally, video encoder 30 may use flag values included in each HPS to determine the specific portions of header information (e.g., parameters) included in each HPS. Based on the HPS IDs referenced by a slice header, and the information included in the referenced HPSs, video decoder 30 may inherit specific parameters from each referenced HPS to decode the slice header that references the HPSs.

By inheriting parameters from the HPSs into one or more slice headers, video decoder 30 may conserve computing resources that video decoder 30 may otherwise expend in decoding the AU. As described with respect to video encoder 20, a potential advantage of these implementations is that a single HPS need not include all parameters available for inheritance to the slice headers of the AU. Additionally, these implementations may expand the available inheritance sources for the slice headers to include multiple HPSs, further mitigating the need for video decoder 30 to duplicate the decoding process with respect to shared parameters of multiple slice headers of the AU.

In various examples, video encoder 20 may inherit parameters from one or more HPSs into one or more slice headers of the corresponding AU, and signal the parameter values as part of the slice headers. In these examples, video encoder 20 may not signal the HPSs, as the slice headers are signaled with the parameter values already being set. According to such examples, video decoder 30 may be blind to the HPS-based techniques implemented by video encoder 20. In other words, video decoder 30 may decode the signaled slice headers without needing to receive, decode, or otherwise process encoded data corresponding to the one or more HPSs. In other examples, as described above, video encoder 20 may signal the HPSs, and may signal the slice headers to reference specific HPSs, thereby enabling video decoder 30 to implement one or more techniques of this disclosure to use the HPSs in decoding the slice headers of an AU.

According to specific examples of this disclosure, one or both of video encoder 20 and video decoder 30 may use particular portions of a NAL unit header to indicate the applicability of an HPS to a particular slice header. More specifically, video encoder 20 may indicate the applicability of an HPS to a slice header, by using reserved portions of the header of a VCL NAL unit that includes the slice header. For instance, video encoder 20 may use a syntax element referred to as the reserved_one_{—}5 bits of the VCL NAL unit header to reference one or more HPSs included in the same AU as the VCL NAL unit. The reserved_one_{—}5 bits syntax element of the NAL unit header may be referred to herein as a layer_id_minus1 syntax element, when used by video encoder 20 to indicate the applicability of an HPS. In turn, video decoder 30 may determine the applicability of a particular HPS to a slice header, based on whether the layer_id_minus1 syntax element of the header of the VCL NAL unit including the slice header references the HPS.

According to these examples, one or both of video encoder 20 and video decoder 30 may use the layer_id_minus1 syntax element to reference one or more HPSs in the same AU as the VCL NAL unit. Additionally, the number of HPSs included in the AU may be less than the number of layers in a corresponding encoded bitstream that video encoder 20 may generate for signaling the AU. As described above, the term “layer” may be used herein to refer to a layer in the context of scalable coding, a view in the context of multiview coding, or a combination of a view and an indication of whether the current NAL unit belongs to texture or depth in three-dimensional video (3DV) coding.

Additionally, video encoder 20 and/or video decoder 30 may identify each layer using a corresponding unique identifier, such as a “layerID” syntax element. In examples, video encoder 20 may generate the value of the layerID syntax element from the existing layer_id_minus1 syntax element, using the following equation: layerID=layer_id_minus1+1. In such examples, video decoder 30 may use the signaled layerID value to determine the corresponding layerID associated with particular HPSs and slice headers signaled in the encoded bitstream.

In such examples, video encoder 20 and/or video decoder 30 may determine that a slice header for a slice belonging to a particular layer may inherit parameters from the HPS associated with the closest lower layer. For instance, an HPS of the AU may be associated with a layerID value of N. In ascending order of layerID values, the next HPS of the AU may be associated with a layerID value of M, where M has a value greater than N. In this example, all slice headers associated with layerID values in the range of (N, M−1) may inherit parameters from the HPS associated with layerID N. Similarly, slice headers associated with a layerID value of M may inherit parameters from the HPS associated with the layerID value of M.

In the context of the example described above, the HPSs associated with layerID values N and M may be referred to herein as “neighboring” HPSs. More specifically, even if layerID values exist between N and M, but none of the intervening layerIDs is associated with an HPS, then the HPSs associated with layerIDs N and M are considered to be neighboring HPSs. Additionally, multiple HPSs may be associated with a single layerID value. For instance, two or more HPSs may be associated with layerID N.

In accordance with one or more aspects of this disclosure, one or both of video encoder 20 and video decoder 30 may determine an HPS by reusing particular portions of one or more neighboring HPSs that are associated with a lesser layerID value. For instance, to determine an HPS using a neighboring HPS, video encoder 20 and/or video decoder 30 may reuse the data specified in a neighboring HPS at a lesser layerID. In the context of the example above, video encoder 20 and/or video decoder 30 may determine an HPS associated with layerID M, by reusing portions of one or more HPSs associated with layerID N.

For instance, if exactly one HPS is associated with layerID N, then video encoder 20 and/or video decoder 30 may reuse portions of the HPS at layerID N, to determine values of an HPS at layerID M. More specifically, video encoder 20 and/or video decoder 30 may determine that the determined HPS at layerID M references the single HPS at layerID N, and reuse the pertinent portions of the neighboring HPS at layerID N to determine the HPS at layerID M. In scenarios where multiple HPSs are associated with layerID N, video encoder 20 and/or video decoder 30 may determine the HPS at layerID M by reusing pertinent portions of particular neighboring HPSs (at layerID N), that are referenced by the HPS at layerID M.

More specifically, if the HPS at layerID M references a single neighboring HPS selected from multiple neighboring HPSs at layerID N, video encoder 20 and/or video decoder 30 may reuse portions of only the referenced neighboring HPS. On the other hand, if the HPS at layerID M references two or more of the multiple neighboring HPSs at layerID N, then video encoder 20 and/or video decoder 30 may reuse pertinent portions of each of the referenced neighboring HPSs to determine the HPS at layerID M. For instance, video encoder 20 may, to signal the HPS at layerID M, signal the reused portions of each of the referenced neighboring HPSs. Additionally, in some scenarios, video encoder 20 and/or video decoder 30 may disable determination of HPSs based on reusing neighboring HPSs. For instance, if video encoder 20 and/or video decoder 30 determine that the respective layers identified by layerIDs N and M do not exhibit inter-layer dependency (e.g., in terms of video data), then video encoder 20 and/or video decoder 30 may disable the inter-dependent HPS determination between these two layers.

In some instances of inter-layer, inter-dependent HPS determination described above, video encoder 20 and/or video decoder 30 may implement techniques similar to depth-first tree-traversal processes. An example of depth-first tree-traversal includes beginning at a root node (in this case, a lowest layer), and traversing the full path to a leaf node (in this case, a highest layer), before backtracking and traversing paths defined by an earliest node having two or more child nodes. More specifically, video encoder 20 and/or video decoder 30 may process the layer (expressed by the layerID value) of the current HPS as a leaf node, or alternatively, as a child node of a next lower layer including an HPS, which forms the corresponding parent node. Additionally, video encoder 20 and/or video decoder 30 may determine that the next lower layer including an HPS includes one or more reference HPSs for the current HPS, i.e., that a portion of the current HPS may be determined based on the reference HPSs via parameter reuse.

To determine the layerID associated with the reference HPSs, video encoder 20 and/or video decoder 30 may determine that the layer including the current HPS is a child node of a tree. Examples of a child node may include any node except for the root node of the tree, such as any intermediate node or any leaf node of the tree. If video encoder 20 and/or video decoder 30 determines that the immediately preceding (lower) layer of the tree is not associated with an HPS, then video encoder 20 and/or video decoder 30 may decrement the value of the child node to equal the layerID for the immediately preceding layer. Video encoder 20 and/or video decoder 30 may recursively decrement the value of the child node until video encoder 20 and/or video decoder 30 reaches a layerID that is associated with one or more potential reference HPSs. In this manner, video encoder 20 and/or video decoder 30 may determine the layerID (referred to herein as refLayerID) of one or more potential reference HPSs for a current HPS. In examples where video encoder 20 and/or video decoder 30 enable inter-layer HPS dependency based on inter-layer dependency for video data, video encoder 20 and/or video decoder 30 may determine that the encoded bitstream includes, with respect to each HPS determined inter-dependently, the corresponding refLayerID associated with the reference HPSs.

In some examples in accordance with the techniques of this disclosure, video encoder 20 and/or video decoder 30 may determine that an HPS is applicable only within the AU that includes the non-VCL NAL unit encapsulating the HPS. In such scenarios, video encoder 20 and/or video decoder 30 may determine that data included in the VCL NAL unit encapsulating the encoded slice headers activates one or more of the corresponding VPS, SPS, PPS, or APS. Based on various factors, the slice headers may activate one or more of these parameter sets directly (e.g., by referencing the particular parameter sets), or indirectly (e.g., by referencing the non VCL NAL unit of the HPS, which may in turn reference the particular parameter sets).

According to other aspects of this disclosure, video encoder 20 and/or video decoder 30 may determine that each slice header of an AU references at least one HPS. In such cases, video encoder 20 and/or video decoder 30 may determine that the non-VCL NAL units that include referenced HPSs activate one or more of the VPS, SPS, PPS, and optionally, the APS. In other words, according to these aspects of this disclosure, a slice header may not directly activate one or more of the VPS, SPS, PPS, and the APS, but instead, may indirectly activate one or more of these parameter sets via referencing one or more HPSs.

According to some implementations of the techniques of this disclosure, video encoder 20 and/or video decoder 30 may implement one of two available modes, with respect to the use of HPSs. In a first mode, video encoder 20 and/or video decoder 30 may determine that any HPS may only apply to slice headers that are included in the same AU as the non-VCL NAL unit encapsulating the HPS. In other words, according to the first mode, “lifetime” of an HPS may be limited or bounded within a single AU. According to a second mode, video encoder 20 and/or video decoder 30 may determine that an HPS includes parameters that are potentially inheritable to slice headers of the current AU, as well as slice headers of other AUs. Implementation of the second mode may enable the slice header(s) to activate the applicable HPSs. As used herein, HPS activation may be analogous to APS activation, as defined in the current HEVC working draft (WD9). As described above with respect to other implementations, slice headers may activate one or more of the VPS, SPS, PPS, and APS directly (e.g., by referencing the particular parameter sets), or indirectly (e.g., by referencing the non VCL NAL unit of the HPS, which may in turn reference the particular parameter sets).

In this manner, one or both of source device 12 and destination device 14 may be an example of a device for coding video data, comprising a video coder, namely, video encoder 20 and video decoder 30, respectively. Additionally, in accordance with the techniques described above, one or both of video encoder 20 and video decoder 30 may be examples of a video coder configured to determine a header parameter set that includes one or more syntax elements specified individually by each of one or more slice headers, and determine the one or more slice headers that reference the header parameter set to inherit at least one of the syntax elements included in the header parameter set, where the slice headers are each associated with a slice of encoded video data.

Additionally, according to one or more aspects described above, to determine the header parameter set, the video coder may be configured to determine the header parameter set for an access unit that includes one or more slice headers, and the header parameter set for the access unit includes the one or more syntax elements for any slices associated with the access unit but not for any slices associated with a different access unit. In accordance with one or more aspects of the described techniques, to determine the header parameter set, the video coder is configured to determine the header parameter set for an access unit different than an access unit that includes the header parameter set and the one or more slice headers, and the header parameter set determined for the access unit includes the one or more syntax elements for any slices associated with one or both of the access unit different than the access unit that includes the header parameter set and the access unit that includes the header parameter set.

In some example implementations of the techniques described above, to determine the header parameter set, the video coder is configured to determine the header parameter set for a first layer of the encoded video data. According to some of these implementations, to determine the header parameter set for a first layer of the encoded video data, the video coder is configured to determine the header parameter set for a first layer of the encoded video data that inherits syntax elements specified in a header parameter set for a second layer of the encoded video data. In one such implementation, the second layer is a lower layer than the first layer. In another such implementation, to determine the one or more slice headers, the video coder is configured to determine a slice header that references at least one of the syntax elements included within the header parameter set for the first layer and at least one syntax element included within the header parameter set for the second layer.

In still another such implementation, the first layer of the encoded video data provides encoded video data that augments the second layer of the encoded video data to enable higher resolutions of the encoded video data. According to yet another such implementation, the first layer of the encoded video data provides a different view than a view provided by the second layer of the encoded video data. In some examples, the device (e.g., source device 12 and/or destination device 14) that includes the video coder may include an integrated circuit, a microprocessor, and a communication device that includes the video coder.

As described above, in some instances, the video coder comprises a video decoder, such as video decoder 30, configured to entropy decode the encoded video data. In other instances, the video coder comprises a video encoder, such as video encoder 20, configured to entropy encode the encoded video data. It will be appreciated that, in some implementations, video decoder 30 may also be configured to encode video data.

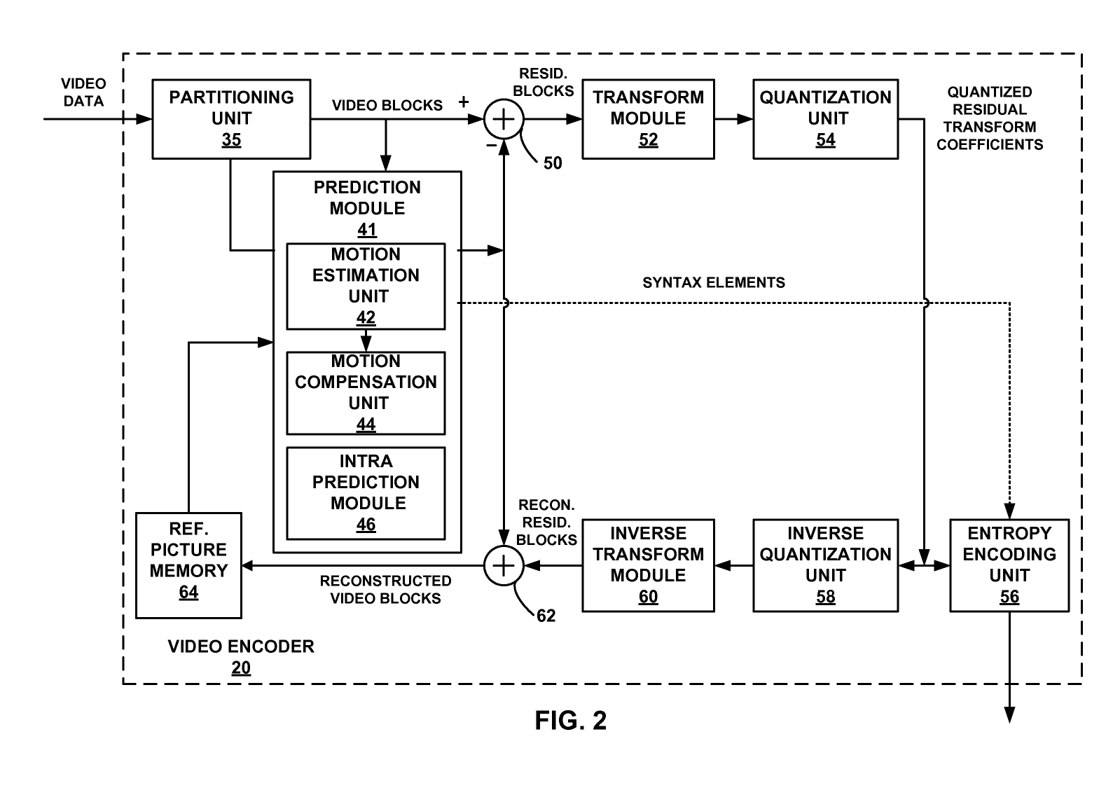

FIG. 2 is a block diagram illustrating an example of video encoder 20 that may implement techniques for signaling data for LTRPs in an SPS or slice header. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma coding blocks, and motion compensation unit 44 uses motion vectors calculated based on the luma coding blocks for both chroma coding blocks and luma coding blocks. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

Entropy encoding unit 56 of video encoder 20 may be configured to implement one or more of techniques of this disclosure to utilize a header parameter set (HPS) in generating and signaling encoded video data and corresponding parameters to represent an access unit (AU). Entropy encoding unit 56 may implement techniques of this disclosure to utilize an HPS to more efficiently and reliably encode and signal the slice headers of a picture. Additionally, entropy encoding unit 56 may utilize the HPS-based techniques of this disclosure to enable a decoding device, such as video decoder 30, to more efficiently decode the encoded AU. In one implementation of the techniques, entropy encoding unit 56 may generate an HPS that includes one or more syntax elements specified individually in each of one or more slice headers for an encoded picture. For instance, entropy encoding unit 56 may generate the HPS such that the HPS includes one or more syntax elements that are common to all slice headers of the encoded picture. As another example, entropy encoding unit 56 may generate the HPS such that the HPS includes one or more syntax elements that are common to two or more slice headers of the encoded picture, but not common to all slice headers of the encoded picture.

Additionally, entropy encoding unit 56 may generate one or more slice headers of the encoded picture to reference the HPS. More specifically, by generating the slice headers to reference the HPS, entropy encoding unit 56 may incorporate at least one of the syntax elements of the HPS into the particular slice headers that reference the HPS. In other words, entropy encoding unit 56 may generate the values of portions of such slice headers, by inheriting particular syntax elements from the HPS into the slice headers that reference the HPS. By generating multiple slice headers to inherit syntax elements of the same values from the HPS, entropy encoding unit 56 may implement the techniques of this disclosure to mitigate, or potentially eliminate, duplicate generation of shared syntax elements for multiple slice headers. Instead, by implementing the techniques, entropy encoding unit 56 may generate the shared syntax elements once, with respect to generating the HPS, and generate multiple slice headers to inherit the shared syntax elements from the HPS, thereby conserving computing resources and bandwidth/storage capacity required for signaling.

According to one implementation of the techniques described herein, entropy encoding unit 56 may generate an HPS such that the HPS is included in a different NAL unit from one or more NAL units that include the encoded video data corresponding to the picture. For instance, entropy encoding unit 56 may encapsulate the HPS in a particular NAL unit, and encapsulate data for the encoded picture (e.g., including the corresponding slice headers and encoded blocks arranged in slices) in a different NAL unit. Additionally, entropy encoding unit 56 may signal the NAL units separately, i.e., entropy encoding unit 56 may signal the encoded HPS and the encoded picture in separate NAL units.

Additionally, according to this implementation, entropy encoding unit 56 may associate the NAL unit that includes the HPS with one or more NAL units that include encoded slices (and corresponding slice headers) of the encoded picture. More specifically, entropy encoding unit 56 may generate one or more video coding layer (VCL) NAL units that encapsulate the slices and corresponding slice headers of the encoded picture. Conversely, entropy encoding unit 56 may generate a non-VCL NAL unit that encapsulates the HPS. Entropy encoding unit 56 may generate the respective NAL units such that, in combination, the non-VCL NAL unit and the one or more VCL NAL units form entire access unit AU associated with the encoded picture.

In some examples according to this implementation, entropy encoding unit 56 may associate the non-VCL NAL unit encapsulating the HPS with VCL NAL units of the same AU, but not with VCL NAL units of any other AU. In other words, entropy encoding unit 56 may, in these scenarios, generate a particular HPS to include only syntax elements that are eligible to be inherited by slice headers of a single encoded picture.

According to some implementations of the techniques described herein, entropy encoding unit 56 may determine that a single AU includes multiple HPSs. For instance, when encoding a picture according to two-dimensional (2D) video coding, entropy encoding unit 56 may generate each HPS to include a unique identifier (ID). In turn, entropy encoding unit 56 may generate a slice header of the encoded picture, to reference multiple HPSs of the corresponding AU. More specifically, entropy encoding unit 56 may generate the slice header to reference each of the multiple HPSs using the respective ID of each HPS.

By generating a slice header to reference multiple HPSs, entropy encoding unit 56 may inherit particular portions of each referenced HPS in generating the slice header. In this manner, entropy encoding unit 56 may further reduce duplication of data generation with respect to a slice header. More specifically, by inheriting pertinent parameters from multiple HPSs, entropy encoding unit 56 may mitigate the need to generate and encode multiple parameters of the slice header, by expanding the available inheritance sources to include multiple HPSs of the AU. According to these implementations, entropy encoding unit 56 may generate each HPS to include one or more flags. More specifically, entropy encoding unit 56 may set a value of each flag to indicate whether the particular HPS includes specific data, such as specific parameters. In this manner, entropy encoding unit 56 may implement techniques of this disclosure such that each HPS need not include a complete set of parameters available for inheritance into slice headers of the AU.

In various examples, entropy encoding unit 56 may inherit parameters from one or more HPSs into one or more slice headers of the corresponding AU, and signal the parameter values as part of the slice headers. In these examples, entropy encoding unit 56 may not signal the HPSs, as entropy encoding unit 56 may signal the slice headers with the parameter values already being set. According to such examples, entropy encoding unit 56 may generate and use the HPSs in such a manner that a video decoder may be blind to the implemented HPS-based techniques. In other words, according to such examples, a corresponding video decoder may receive the encoded bitstream and decode the signaled slice headers without requiring entropy encoding unit 56 to signal encoded data corresponding to the one or more HPSs. In other examples, as described above, entropy encoding unit 56 may signal the HPSs, and may signal the slice headers to reference specific HPSs, thereby enabling a video decoder to implement one or more techniques of this disclosure to use the HPSs in decoding the slice headers of an AU.

According to specific examples of this disclosure, entropy encoding unit 56 may use particular portions of a NAL unit header to indicate the applicability of an HPS to a particular slice header. More specifically, entropy encoding unit 56 may indicate the applicability of an HPS to a slice header, by using reserved portions of the header of a VCL NAL unit that includes the slice header. For instance, entropy encoding unit 56 may use a syntax element referred to as the reserved_one_{—}5 bits (referred to in the context of the techniques described herein as a layer_id_minus1) syntax element of the VCL NAL unit header to reference one or more HPSs included in the same AU as the VCL NAL unit. In this example, entropy encoding unit 56 may enable a video decoder to determine the applicability of a particular HPS to a slice header, based on whether the layer_id_minus1 syntax element of the header of the signaled VCL NAL unit that encapsulates the slice header references the HPS.

According to these examples, entropy encoding unit 56 may use the layer_id_minus1 syntax element to reference one or more HPSs in the same AU as the VCL NAL unit. Additionally, the number of HPSs included in the AU may be less than the number of layers in a corresponding encoded bitstream that entropy encoding unit 56 generates for signaling the AU. As described above, the term “layer” may be used herein to refer to a layer in the context of scalable coding, a view in the context of multiview coding, or a combination of a view and an indication of whether the current NAL unit belongs to texture or depth in three-dimensional video (3DV) coding.

Additionally, entropy encoding unit 56 may identify each layer using a corresponding unique identifier, such as a “layerID” syntax element. In examples, entropy encoding unit 56 may generate the value of the layerID syntax element from the existing layer_id_minus1 syntax element, using the following equation: layerID=layer_id_minus1+1. In such examples, entropy encoding unit 56 may enable a video decoder to use the signaled layerID value to determine the corresponding layerID associated with particular HPSs and slice headers signaled in the encoded bitstream.

In such examples, entropy encoding unit 56 may determine that a slice header for a slice belonging to a particular layer is eligible to inherit parameters from the HPS associated with the closest lower layer. As one example, an HPS of the AU may be associated with a layerID value of N. In ascending order of layerID values, the next HPS of the AU may be associated with a layerID value of M, where M has a value greater than N. In this example, entropy encoding unit 56 may determine that all slice headers associated with layerID values in the range of (N, M−1) are eligible to inherit parameters from the HPS associated with layerID N. Similarly, entropy encoding unit 56 may determine that slice headers associated with a layerID value of M are eligible to inherit parameters from the HPS associated with the layerID value of M.

In the context of the example described above, the HPSs associated with layerID values N and M may be referred to herein as “neighboring” HPSs. More specifically, even if layerID values exist between N and M, but none of the intervening layerIDs is associated with an HPS, then the HPSs associated with layerIDs N and M are considered to be neighboring HPSs. Additionally, entropy encoding unit 56 may associate multiple HPSs with a single layerID value. For instance, entropy encoding unit 56 may associate two or more HPSs with layerID N.

In accordance with one or more aspects of this disclosure, entropy encoding unit 56 may generate an HPS by reusing pertinent portions of one or more neighboring HPSs that are associated with a lesser layerID value. For instance, to generate an HPS using a neighboring HPS, entropy encoding unit 56 may reuse the data specified in a neighboring HPS at a lesser layerID. In the context of the example above, entropy encoding unit 56 may generate an HPS associated with layerID M, by reusing portions of one or more HPSs associated with layerID N.

For instance, if exactly one HPS is associated with layerID N, then entropy encoding unit 56 may reuse portions of the HPS at layerID N, to generate values of an HPS at layerID M. More specifically, entropy encoding unit 56 may determine that the generated HPS at layerID M references the single HPS at layerID N, and reuse the pertinent portions of the neighboring HPS at layerID N to generate the HPS at layerID M. In scenarios where multiple HPSs are associated with layerID N, entropy encoding unit 56 may generate the HPS at layerID M by reusing pertinent portions of particular neighboring HPSs (at layerID N), that are referenced by the HPS at layerID M.

More specifically, if the HPS associated with layerID M references a single neighboring HPS selected from multiple neighboring HPSs at layerID N, entropy encoding unit 56 may reuse portions of only the referenced neighboring HPS, to generate the HPS at layerID M. On the other hand, if the HPS at layerID M references two or more of the multiple neighboring HPSs at layerID N, then entropy encoding unit 56 may reuse pertinent portions of each of the referenced neighboring HPSs to generate the HPS at layerID M. For instance, entropy encoding unit 56 may, in order to signal the HPS at layerID M, signal the reused portions of each of the referenced neighboring HPSs. Additionally, in some scenarios, entropy encoding unit 56 (or one or more other components of video encoder 20) may disable inter-dependent HPS generation based on neighboring HPSs. For instance, if entropy encoding unit 56 determines that the respective layers identified by layerIDs N and M do not exhibit inter-layer dependency (e.g., in terms of video data), then entropy encoding unit 56 may disable the inter-dependent HPS generation between these two layers.

In some instances of inter-layer, inter-dependent HPS generation described above, video entropy encoding unit 56 may implement techniques similar to depth-first tree-traversal processes, as described above. More specifically, entropy encoding unit 56 may process the layer (expressed by the layerID value) of the current HPS as a leaf node, or alternatively, as a child node of a next lower layer including an HPS, which forms the corresponding parent node. Additionally, entropy encoding unit 56 may determine that the next lower layer to include an HPS includes one or more reference HPSs for the current HPS. In other words, entropy encoding unit 56 may determine that a portion of the current HPS is eligible to be generated from the reference HPSs via parameter reuse.

To determine the layerID associated with the reference HPSs, entropy encoding unit 56 may determine that the layer including the current HPS is a child node, such as an intermediate node or a leaf node, of a tree. In examples, entropy encoding unit 56 may determine that the immediately preceding (lower) layer, represented as the parent node of the current node, is not associated with an HPS. In such scenarios, entropy encoding unit 56 may decrement the value of the child node to equal the value of the parent node, i.e., the layerID for the immediately preceding layer. Additionally, entropy encoding unit 56 may iteratively decrement the value of the child node until reaching a layerID that is associated with one or more potential reference HPSs.

In this manner, entropy encoding unit 56 may determine the layerID (referred to herein as refLayerID) of one or more potential reference HPSs for a current HPS. In examples where entropy encoding unit 56 enables inter-layer HPS dependency based on inter-layer dependency for video data, entropy encoding unit 56 may determine that the encoded bitstream includes, with respect to each inter-dependently generated HPS, the corresponding refLayerID associated with the reference HPSs. Additionally, upon identifying the one or more reference HPSs, entropy encoding unit 56 may generate the current HPS by reusing portions of the identified one or more reference HPSs.

According to one or more examples of this disclosure, entropy encoding unit 56 may determine that an HPS is applicable only within the AU that includes the non-VCL NAL unit encapsulating the HPS. In such scenarios, entropy encoding unit 56 may determine that data included in the VCL NAL unit encapsulating the encoded slice headers activates one or more of the corresponding VPS, SPS, PPS, or APS. Based on various factors, the slice headers may activate one or more of these parameter sets directly (e.g., by referencing the particular parameter sets), or indirectly (e.g., by referencing the non VCL NAL unit of the HPS, which may in turn reference the particular parameter sets). More specifically, entropy encoding unit 56 may generate the slice headers to include data that activates the HPS or one or more of the parameter sets listed above, as the case may be.

According to other examples of this disclosure, entropy encoding unit 56 may determine that each slice header of an AU references at least one HPS. More specifically, in such instances, entropy encoding unit 56 may each slice header of the AU to include data that references at least one HPS, such by indicating the corresponding HPS ID. In such cases, entropy encoding unit 56 may generate the non-VCL NAL units that include referenced HPSs, such that the non-VCL NAL units activate one or more of the VPS, SPS, PPS, and optionally, the APS. In other words, according to these aspects of this disclosure, a slice header may not directly activate one or more of the VPS, SPS, PPS, and the APS, but instead, may indirectly activate one or more of these parameter sets via referencing one or more HPSs.

In some examples, entropy encoding unit 56 may reuse HPS IDs across layers, based on slice headers of a particular layer only referring to HPSs of a particular (e.g., most recent) layer. According to these examples, entropy encoding unit 56 may identify a particular HPS using both the corresponding layerID and the HPS ID within the layer. In other examples, entropy encoding unit 56 may not reuse HPS IDs across layers. According to these examples, entropy encoding unit 56 may identify a particular HPS only by the HPS ID, without specifying a corresponding layerID.

According to some examples of the techniques of this disclosure, entropy encoding unit 56 may implement one of two available modes, with respect to the use of HPSs. In a first mode, entropy encoding unit 56 may determine that any generated HPS may only apply to slice headers that are included in the same AU as the non-VCL NAL unit encapsulating the HPS. According to a second mode, entropy encoding unit 56 may determine that an HPS includes parameters that are potentially inheritable to slice headers of the current AU, as well as slice headers of other AUs. In instances where entropy encoding unit 56 implements the second mode, entropy encoding unit 56 may enable the slice header(s) to activate the applicable HPSs. As used herein, HPS activation may be analogous to APS activation, as defined in the current HEVC working draft (WD9). As described above with respect to other implementations, entropy encoding unit 56 may encode one or more slice headers, such that the slice headers may activate one or more of the VPS, SPS, PPS, and APS directly (e.g., by referencing the particular parameter sets), or indirectly (e.g., by referencing the non VCL NAL unit of the HPS, which may in turn reference the particular parameter sets).

As described with respect to FIG. 2, video encoder 20 and/or components thereof may perform a method of encoding video data, the method including generating a header parameter set that includes one or more syntax elements specified individually by each of one or more slice headers, and generating the one or more slice headers to reference the header parameter set to inherit at least one of the syntax elements included in the header parameter set, where the slice headers are each associated with a slice of the encoded video data. In some example implementations of the method described above with respect to video encoder 20, generating the header parameter set may include generating the header parameter set for an access unit that includes the one or more slice headers, where the header parameter set generated for the access unit includes the one or more syntax elements for any slices associated with the access unit but not for any slices associated with a different access unit.

In some examples of the method described above with respect to video encoder 20, generating the header parameter set may include generating the header parameter set for an access unit different than an access unit that includes the header parameter set and the one or more slice headers, where the header parameter set generated for the access unit includes the one or more syntax elements for any slices associated with one or both of the access unit different than the access unit that includes the header parameter set and the access unit that includes the header parameter set.

According to some examples of the method described above with respect to video encoder 20, generating the header parameter set may include generating the header parameter set for a first layer of the video data. In some of these implementations, generating the header parameter set for a first layer of the video data may include generating the header parameter set for a first layer of the video data that inherits syntax elements specified in a header parameter set for a second layer of the video data.

In one example, the second layer is a lower layer than the first layer. According to another example, generating the one or more slice headers may include generating a slice header that references at least one of the syntax elements included within the header parameter set for the first layer and at least one syntax element included within the header parameter set for the second layer. In still another example, the first layer of the video data provides video data that augments the second layer of the video data to enable higher resolutions of the video data. According to yet another example, the first layer of the video data provides a different view than a view provided by the second layer of the video data.

In some examples, video encoder 20 may be included in a device for coding video data, such as a desktop computer, notebook (i.e., laptop) computer, tablet computer, set-top box, telephone handset such as a so-called “smart” phone, so-called “smart” pad, television, camera, display device, digital media player, video gaming console, video streaming device, or the like. In these or other examples, such a device for coding video data may include one or more of an integrated circuit, a microprocessor, and a communication device that includes video encoder 20. In some examples, video encoder 20 may also be configured to decode encoded video data, such as through entropy decoding the encoded video data.

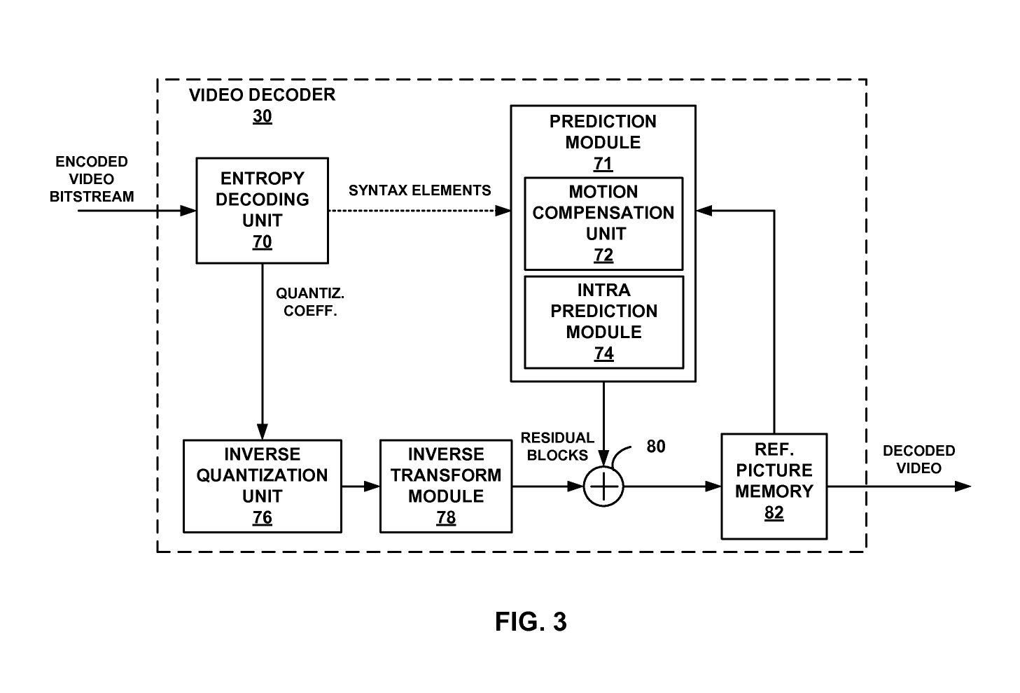

FIG. 3 is a block diagram illustrating an example of video decoder 30 that may implement techniques for decoding video data that has been encoded using parallel motion estimation. In the example of FIG. 3, video decoder 30 includes an entropy decoding unit 70, motion compensation unit 72, intra prediction module 74, inverse quantization unit 76, inverse transform module 78, summer 80, and reference picture memory 82. In the example of FIG. 2, video decoder 30 includes prediction module 71, which, in turn, includes motion compensation unit 72 and intra prediction module 74. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra prediction module 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra prediction module 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de quantizes, the quantized transform coefficients provided in the bitstream and decoded by entropy decoding unit 70. The inverse quantization process may include use of a quantization parameter QPY calculated by video decoder 30 for each video block in the video slice to determine a degree of quantization and, likewise, a degree of inverse quantization that should be applied.

Inverse transform module 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform module 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

Video decoder 30, and various components thereof, may implement techniques of this disclosure, such as techniques described with respect to the use of a header parameter set (HPS), to decode one or more slice headers of an access unit (AU) represented by data of the received encoded video bitstream. For instance, entropy decoding unit 70 may implement one or more techniques of this disclosure to utilize a header parameter set (HPS) to more efficiently, accurately, and reliably decode slice headers of an encoded picture represented in the received encoded video bitstream. In some examples, entropy decoding unit 70 may decode the slice headers of an encoded picture, based on determining that an HPS includes one or more syntax elements that would otherwise be specified individually by the one or more slice headers.

More specifically, entropy decoding unit 70 may determine that one or more slice headers of the encoded picture reference an HPS that is signaled as part of the encoded video bitstream. Based on the determination that the particular slice headers reference the HPS, entropy decoding unit 70 may decode the particular slice headers by inheriting certain syntax elements from the HPS into the particular slice headers that reference the HPS. By inheriting syntax elements from the HPS into multiple slice headers of the encoded picture, entropy decoding unit 70 may implement the techniques of this disclosure to mitigate, or potentially eliminate, duplicate decoding of shared syntax elements for multiple slice headers. Instead, by implementing the techniques, entropy decoding unit 70 may decode the shared syntax elements once, with respect to decoding the HPS, and decode multiple slice headers by inheriting the shared syntax elements from the HPS. By using the HPS to decode multiple slice headers, entropy decoding unit 70 may conserve computing resources that video decoder 30 may otherwise expend in decoding the encoded picture.

According to one example of the techniques described herein, entropy decoding unit 70 may determine that the HPS is included in a different NAL unit than the encoded data corresponding to the picture. For instance, entropy decoding unit 70 may receive separate NAL units, with one NAL unit encapsulating the HPS, and one or more different NAL units that encapsulate the encoded slices and corresponding slice headers of the picture. Additionally, entropy decoding unit 70 may determine that a received non-VCL unit encapsulates the encoded HPS, while one or more VCL NAL units encapsulate the encoded slices and slice headers of the picture. More specifically, entropy decoding unit 70 may determine that the non-VCL NAL unit encapsulating the HPS and the one or more VCL units encapsulating the encoded slices and slice headers combine to form a single AU that corresponds to the encoded picture.

In some examples, entropy decoding unit 70 may determine that the non-VCL NAL unit encapsulating the HPS is associated with VCL NAL units of the same AU, but not with VCL NAL units of another AU. In other words, entropy decoding unit 70 may determine, in these scenarios, that a particular HPS only includes syntax elements that may be inherited by slice headers of a single encoded picture. Based on this determination, entropy decoding unit 70 may determine that slices of a first AU are eligible to inherit parameter data from the HPS of the first AU, but may determine that slice headers of a second AU are not eligible to inherit any parameter data from the HPS of the first AU.

According to some examples of the techniques described herein, entropy decoding unit 70 may determine that a single AU includes multiple HPSs. For instance, when decoding a picture according to two-dimensional (2D) video coding, entropy decoding unit 70 may identify each HPS based on a unique identifier (HPS ID) included in each respective HPS. In turn, entropy decoding unit 70 may determine that a slice header of the encoded picture references multiple HPSs of the corresponding AU. More specifically, entropy decoding unit 70 may entropy decode the slice header to determine that the slice header references each of the multiple HPSs by specifying the respective ID of each HPS.

By determining that a slice header references multiple HPSs, entropy decoding unit 70 may inherit particular portions of each referenced HPS in decoding the slice header, and thereby, the corresponding slice of the encoded picture. Additionally, entropy decoding unit 70 may use flag values included in each HPS to determine the specific portions of header information (e.g., parameters) included in each HPS. Based on the HPS IDs referenced by a slice header, and the information included in the referenced HPSs, entropy decoding unit 70 may decode the slice header by inheriting specific parameters from each referenced HPS to decode the slice header that references the HPSs.

By inheriting parameters from the HPSs into one or more slice headers, entropy decoding unit 70 may conserve computing resources that video decoder 30 may otherwise expend in decoding the AU. A potential advantage of these implementations is that a single HPS need not include all parameters available for inheritance to the slice headers of the AU. Additionally, these implementations may expand the available inheritance sources for the slice headers to include multiple HPSs, further mitigating the need for entropy decoding unit 70 to duplicate the decoding process with respect to shared parameters of multiple slice headers of the AU.

In various examples, video decoder 30 and components thereof, such as entropy decoding unit 70, may be blind to the HPS-based techniques implemented by a video encoder that signals the encoded video bitstream. In other words, entropy decoding unit 70 may decode the signaled slice headers without needing to receive, decode, or otherwise process encoded data corresponding to the one or more HPSs. In other examples, as described above, entropy decoding unit 70 may receive the slice headers and specific HPSs referenced by the slice headers. In these examples, entropy decoding unit 70 may implement one or more techniques of this disclosure to use the HPSs in decoding the slice headers of an AU.

According to some specific examples of this disclosure, entropy decoding unit 70 may use particular portions of a NAL unit header to whether, and to what extent, an HPS is applicable to a particular slice header. More specifically, entropy decoding unit 70 may determine whether an HPS is applicable to a slice header, based on data indicated at reserved portions of the header of a VCL NAL unit that includes the slice header. In some instances, entropy decoding unit 70 may also determine the specific portions of the HPS that are applicable to the slice header, using the data indicated by the reserved portions of the VCL NAL unit header. For instance, entropy decoding unit 70 may determine the value of a syntax element referred to as the reserved_one_{—}5 bits (also referred to herein as the layer_id_minus1) of the VCL NAL unit header to determine that a slice header in the VCL NAL unit references one or more HPSs included in the same AU.

According to these or other examples described herein, entropy decoding unit 70 may use the layer_id_minus1 syntax element to associate one or more HPSs with slice headers that are in the same AU. Additionally, the number of HPSs included in the AU may be less than the number of layers in the encoded video bitstream received by entropy decoding unit 70. As described above, the term “layer” may be used herein to refer to a layer in the context of scalable coding, a view in the context of multiview coding, or a combination of a view and an indication of whether the current NAL unit belongs to texture or depth in three-dimensional video (3DV) coding.

Additionally, entropy decoding unit 70 may identify each layer using a corresponding unique identifier, such as a “layerID” syntax element. In examples, the value of the layerID syntax element may be based on the existing layer_id_minus1 syntax element, e.g., as expressed by the following equation: layerID=layer_id_minus1+1. In such examples, entropy decoding unit 70 may use the signaled layerID value to determine the corresponding layerID associated with particular HPSs and slice headers signaled in the encoded video bitstream.

In such examples, entropy decoding unit 70 may determine that a slice header for a slice belonging to a particular layer may inherit parameters from the HPS associated with the closest lower layer. For instance, an HPS of the AU may be associated with a layerID value of N. In ascending order of layerID values, the next HPS of the AU may be associated with a layerID value of M, where M has a value greater than N. In this example, all slice headers associated with layerID values in the range of (N, M−1) may inherit parameters from the HPS associated with layerID N. Similarly, slice headers associated with a layerID value of M may inherit parameters from the HPS associated with the layerID value of M.

In the context of one or more of the examples described above, the HPSs associated with layerID values N and M may be referred to herein as “neighboring” HPSs. More specifically, even if layerID values exist between N and M, but none of the intervening layerIDs is associated with an HPS, then the HPSs associated with layerIDs N and M are considered to be neighboring HPSs. Additionally, multiple HPSs may be associated with a single layerID value. For instance, two or more HPSs may be associated with layerID N.

According to one or more examples of this disclosure, entropy decoding unit 70 may decode an HPS using one or more neighboring HPSs that are associated with a lesser layerID value. For instance, to decode an HPS from a neighboring HPS, entropy decoding unit 70 may reuse the data specified in a neighboring HPS at a lesser layerID. In the context of the example above, entropy decoding unit 70 may determine an HPS associated with layerID M, by reusing portions of one or more HPSs associated with layerID N.

For instance, if exactly one HPS is associated with layerID N, then entropy decoding unit 70 may reuse portions of the HPS at layerID N, to decode values of an HPS at layerID M. More specifically, entropy decoding unit 70 may determine that the inter-dependently decoded HPS at layerID M references the single HPS at layerID N, and reuse the relevant portions of the neighboring HPS at layerID N to decode the HPS at layerID M. In scenarios where multiple HPSs are associated with layerID N, entropy decoding unit 70 may decode the HPS at layerID M by reusing pertinent portions of particular neighboring HPSs (at layerID N), that are referenced by the HPS at layerID M.

More specifically, if the HPS at layerID M references a single neighboring HPS selected from multiple neighboring HPSs at layerID N, entropy decoding unit 70 may reuse portions of only the referenced neighboring HPS, to decode the HPS at layerID M. On the other hand, if the HPS at layerID M references two or more of the multiple neighboring HPSs at layerID N, then entropy decoding unit 70 may reuse pertinent portions of each of the referenced neighboring HPSs to decode the HPS at layerID M. In one example, entropy decoding unit 70 may, to entropy decode the HPS at layerID M, reuse pertinent decoded portions of each of the referenced neighboring HPSs. Additionally, in some scenarios, entropy decoding unit 70, and/or other components of video decoder 30, may disable inter-dependent decoding of HPSs from neighboring HPSs. For instance, if entropy decoding unit 70 determines that the respective layers identified by layerIDs N and M do not exhibit inter-layer dependency (e.g., in terms of video data), then entropy decoding unit 70 may disable the inter-dependent HPS decoding between the respective layers identified by layerIDs N and M.

In some instances of inter-layer, inter-dependent HPS decoding described above, entropy decoding unit 70 may implement techniques similar to depth-first tree-traversal processes, as described above. More specifically, entropy decoding unit 70 may process the layer (expressed by the layerID value) of the current HPS as a leaf node, or alternatively, as a child node of a next lower layer to include an HPS. In other words, entropy decoding unit 70 may determine that the next lower layer to include an HPS forms the parent node. Additionally, entropy decoding unit 70 may determine that the layer corresponding to the parent node includes one or more reference HPSs for the current HPS, i.e., that a portion of the current HPS may be inter-dependently decoded based on the reference HPSs via parameter reuse.

To determine the layerID associated with the reference HPSs, entropy decoding unit 70 may determine that the layer including the current HPS is a child node, such as an intermediate node or a leaf node, of a tree. If entropy decoding unit 70 determines that the immediately preceding (lower) layer of the tree is not associated with an HPS, then entropy decoding unit 70 may decrement the value of the child node to equal the layerID for the immediately preceding layer. Additionally, entropy decoding unit 70 may recursively decrement the value of the child node until entropy decoding unit 70 reaches a layerID that is associated with one or more potential reference HPSs. In this manner, entropy decoding unit 70 may determine the layerID (referred to herein as refLayerID) of one or more potential reference HPSs for a current HPS. In examples where entropy decoding unit 70 enables inter-layer HPS dependency based on inter-layer dependency for video data, entropy decoding unit 70 may determine that the received encoded video bitstream includes, with respect to each inter-dependently decoded HPS, the corresponding refLayerID associated with the reference HPSs.

In some examples in accordance with the techniques of this disclosure, entropy decoding unit 70 may determine that an HPS is applicable only within the AU that includes the non-VCL NAL unit encapsulating the HPS. In such scenarios, entropy decoding unit 70 may determine that data included in the VCL NAL unit encapsulating the encoded slice headers activates one or more of the corresponding VPS, SPS, PPS, or APS. Based on various factors, entropy decoding unit 70 may determine that the slice headers either activate one or more of these parameter sets directly (e.g., by referencing the particular parameter sets), or indirectly (e.g., by referencing the non VCL NAL unit of the HPS, which may in turn reference the particular parameter sets).

According to other examples of this disclosure, entropy decoding unit 70 may determine, from the received encoded video bitstream that each slice header of an AU references at least one HPS. In such cases, entropy decoding unit 70 may determine that the non-VCL NAL units that include referenced HPSs activate one or more of the VPS, SPS, PPS, and optionally, the APS. In other words, according to these aspects of this disclosure, entropy decoding unit 70 may determine that a slice header does not directly activate one or more of the VPS, SPS, PPS, and the APS, but instead, that the slice header indirectly activates one or more of these parameter sets via referencing one or more HPSs.

According to some examples of the techniques of this disclosure, entropy decoding unit 70 may operate according to one of two available modes, with respect to the use of HPSs. In a first mode, entropy decoding unit 70 may determine that any HPS included in the received encoded video bitstream applies exclusively to slice headers that are included in the same AU as the non-VCL NAL unit that encapsulates the HPS. According to a second mode, entropy decoding unit 70 may determine that an HPS includes parameters that are potentially inheritable to slice headers of the current AU, as well as slice headers of other AUs. According to the second mode, entropy decoding unit 70 may enable the slice header(s) to activate the applicable HPSs. As used herein, HPS activation may be analogous to APS activation, as defined in the current HEVC working draft (WD9). As described above with respect to other implementations, entropy decoding unit 70 may enable slice headers to activate one or more of the VPS, SPS, PPS, and APS either directly (e.g., by referencing the particular parameter sets), or indirectly (e.g., by referencing the non VCL NAL unit of the HPS, which may in turn reference the particular parameter sets).

As described with respect to FIG. 3, video decoder 30 and/or components thereof may perform a method of decoding video data, the method including determining a header parameter set that includes one or more syntax elements specified individually by each of one or more slice headers, and determining the one or more slice headers that reference the header parameter set to inherit at least one of the syntax elements included in the header parameter set, where the slice headers are each associated with a slice of the encoded video data. In some example implementations of the method described above with respect to video decoder 30, determining the header parameter set may include determining the header parameter set for an access unit that includes one or more slice headers, where the header parameter set for the access unit includes the one or more syntax elements for any slices associated with the access unit but not for any slices associated with a different access unit.

In some examples of the method described above with respect to video decoder 30, determining the header parameter set may include determining the header parameter set for an access unit different than an access unit that includes the header parameter set and the one or more slice headers, where the header parameter set determined for the access unit includes the one or more syntax elements for any slices associated with one or both of the access unit different than the access unit that includes the header parameter set and the access unit that includes the header parameter set.

According to some examples of the method described above with respect to video decoder 30, determining the header parameter set may include determining the header parameter set for a first layer of the encoded video data. In some of these examples, determining the header parameter set for a first layer of the encoded video data may include determining the header parameter set for a first layer of the encoded video data that inherits syntax elements specified in a header parameter set for a second layer of the encoded video data.

In one such example, the second layer is a lower layer than the first layer. According to another example, determining the one or more slice headers may include determining a slice header that references at least one of the syntax elements included within the header parameter set for the first layer and at least one syntax element included within the header parameter set for the second layer. In still another example, the first layer of the video data provides video data that augments the second layer of the video data to enable higher resolutions of the encoded video data. According to yet another example, the first layer of the video data provides a different view than a view provided by the second layer of the encoded video data.

In various examples, video decoder 30 may be included in a device for coding video data, such as a desktop computer, notebook (i.e., laptop) computer, tablet computer, set-top box, telephone handset such as a so-called “smart” phone, so-called “smart” pad, television, camera, display device, digital media player, video gaming console, video streaming device, or the like. In examples, such a device for coding video data may include one or more of an integrated circuit, a microprocessor, and a communication device that includes video decoder 30.

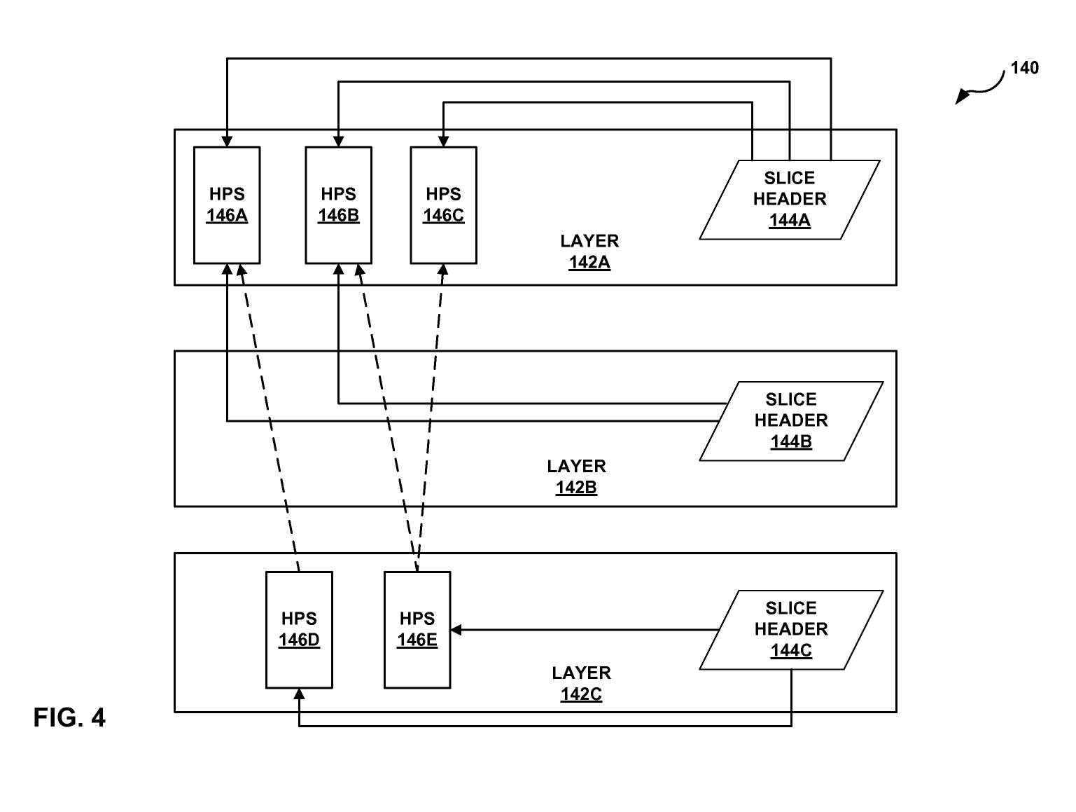

FIG. 4 is a conceptual diagram illustrating an example header parameter set (HPS) model 140 incorporating inter-layer dependency, in accordance with one or more aspects of this disclosure. HPS model 140 illustrates three layers 142A-142C, associated with an access unit (AU). As described above, the term “layer,” as used herein, may refer to a layer in the context of scalable coding, a view in the context of multiview coding, or a combination of a view and an indication of whether the current NAL unit belongs to texture or depth in three-dimensional video (3DV) coding. Additionally, each of layers 142A-142C may also be referred to herein as “enhancement layers.” Although any one or more of the devices and/or components described herein may process HPS model 140, for ease of discussion purposes only, HPS model 140 is described herein with respect to video decoder 30 of FIGS. 1 and 3.

As shown, HPS model 140 includes three slice headers 144A-144C, each being associated with a respective layer of layers 142A-142C. Additionally, HPS model 140 includes three HPSs 146-146C at layer 142A, and two HPSs 146D-146E, at layer 142C. In this disclosure, the three layers 142A-142C are referred to collectively as layers 142, the three slice headers 144A-144C are referred to collectively as slice headers 144, and the five HPSs 146A-146E are referred to collectively as HPSs 146. To decode an AU of an encoded bitstream received from video encoder 20, video decoder 30 may use one or more of HPSs 146, to decode one or more of slice headers 144.

HPS model 140 illustrates a specific example of a scenario in which video decoder 30 may inherit slice header parameters from multiple HPSs 146, either directly or indirectly. More specifically, as used herein, direct inheritance may refer to examples in which video decoder 30 reuses parameters specified, originally in one or more of HPSs 146, in decoding one of slice headers 144. On the other hand, as used herein, indirect inheritance may refer to examples in which video decoder 30 determines that one of slice headers 144 references one or more of HPSs 146, and that, in turn, the referenced one or more of HPSs 146 are inter-dependently decoded based on one or more remaining parameter sets of HPSs 146.

In the example of FIG. 4, layer 142B does not include any of HPSs 146, while each of layers 142A and 142C includes one or more of HPSs 146. In some instances in this disclosure, HPSs 146A-146C may be referred to as “HPS 0,” “HPS 1,” and “HPS 2” with respect to layer 142A (e.g. having a layerID value of 0). Similarly, HPSs 146D and 146E may be referred to herein as “HPS 0” and “HPS 1” with respect to layer 142C. In implementing the techniques of this disclosure, video decoder 30 may determine that HPSs 146A-146C are “neighboring” parameter sets to HPSs 146D-146E. More specifically, video decoder 30 may determine that HPSs 146A-146C neighbor HPSs 146D-146E, even though layer 142B intervenes between the respective layers of HPSs 146A-146C and neighboring HPSs 146D-146E.

Video decoder 30 may determine HPSs 146A-146C neighbor HPSs 146D-146E, based on determining that intervening layer 142B does not include any header parameter sets. In one example use case, video decoder 30 may determine that layer 142A is associated with a layerID value of 0, layer 142B is associated with a layerID value of 1, and layer 142C is associated with a layerID value of 2. Based on the described sequence of layerID values, video decoder 30 may determine that layer 142B is positioned between layers 142A and 142C.

The specific example of HPS model 140 includes particular HPS-slice header dependencies, as well as particular inter-HPS dependencies. For instance, slice header 144A, at layerID 0 in the example above, may exhibit varying dependencies with respect to each of the three HPSs 146A-146C. For example, video decoder 30 may inherit particular parameter values from each of the HPSs 146A-146C, to decode slice header 144A. More specifically, video decoder 30 may inherit particular portions of slice header 144A from each of HPSs 146A-146C. For instance, video decoder 30 may inherit an initial “part 0” of slice header 144A from HPS 146B, a subsequent “part 1” of slice header 144A from HPS 146A, and a still subsequent “part 2” of slice header 144A from HPS 146C.

Additionally, slice header 144A may include additional parameters (e.g., denoted by parts up to “part N”). Video decoder 30 may determine the remaining parts of slice header 144A, up to part N, either by inheriting parameters from HPSs 146A-146C, or by decoding parameters that are explicitly signaled as part of slice header 144A. In other words, video decoder 30 may decode parameters that are present in slice header 144A, or override any values signaled in slice header 144A with parameters signaled in any of HPSs 146A-146C.

Similarly, according to this example, slice header 144B may inherit parameters from one or more of HPSs 146A-146C. As shown in FIG. 4, slice header 144B corresponds to layer 142B, which is associated with a layerID value of 1. According to one or more implementations described herein, video decoder 30 may determine that each of slice headers 144 is eligible to inherit parameters from those of HPSs 146 that are at the same layer as or a lower layer than the respective one of slice headers 144.

For instance, video decoder 30 may determine that slice header 144B is eligible to inherit parameters from HPSs 146A-146C, based on HPSs 146A-146C being positioned at layer 142A, which is associated with a layerID value of 0. In a specific example, video decoder 30 may inherit part 0 and part 1 of slice header 144B from HPS 146A, and may inherit part 2 of slice header 144B from HPS 146B. Additionally, video decoder 30 may decode the remaining parameters of slice header 144B (e.g., denoted by parts up to “part N”) on a case-by-case basis, e.g., either by decoding the parameters directly from slice header 144B, or overriding any data in slice header 144B by inheriting parameters from one or more of HPSs 146A-146C. In this manner, HPS model 140 illustrates an instance of inter-layer dependency of a slice header on one or more HPSs.

It will be appreciated that, in scenarios where layer 142B includes one or more HPSs, video decoder 30 may inherit parts of slice header 144B from any of the HPSs at layer 142B. More specifically, according to such examples, video decoder 30 may inherit parameters to one of slice headers 144, from those of HPSs 146 that are at either the same layer or at a lower layer than the particular slice header 144. For instance, in one such scenario, slice header 144B may inherit parameters directly from an HPS at layer 142B, and inherit parameters, either directly or indirectly, from HPSs 146A-146C at lower layer 142A.

Additionally, HPS model 140 includes slice header 144C at layer 142C. In examples, video decoder 30 may determine that layer 142C is associated with a layerID value of 2. More specifically, based on the layerID value of 2, video decoder 30 may determine that layer 142C is a higher layer than layers 142A and 142B, which, in such examples, may be associated with layerID values of 0 and 1, respectively. In turn, based on aspects of inter-layer dependency as described herein, video decoder 30 may decode portions of slice header 144C by inheriting, either directly or indirectly, parameters specified in HPSs of lower layers 142A and 142B.

In the specific example of HPS model 140, two HPSs, namely HPSs 146D-146E, are positioned at the same layer as slice header 144C. By applying one or more aspects of inter-layer dependency as described herein, video decoder 30 may decode slice header 144C using any of HPSs 146, as all of HPSs 146 are positioned at either the same layer (i.e., layer 142C) as, or at a lower layer (i.e., layer 142A) than slice header 144C. With respect to slice header 144C, HPS model 140 illustrates examples of indirect inheritance.

More specifically, as shown in FIG. 4, video decoder 30 may decode slice header 144C by inheriting particular parameters from each of HPSs 146D-146E, which are positioned at the same layer as slice header 144C. In turn, video decoder 30 may decode each of HPSs 146D-146E by reusing particular portions of each of HPSs 146A-146C. In the specific example of HPS 140, video decoder 30 may inherit portions of HPS 146D from HPS 146A, and may inherit portions of 146E from each of HPSs 146B-146C. It will be appreciated that while video decoder 30 may inherit particular portions of HPSs 146D-146E from one or more of HPSs 146A-146C, video decoder 30 may decode other portions of HPSs 146D-146E directly, based on parameters signaled in an encoded bitstream received by video decoder 30. For instance, video decoder 30 may reuse as many parameters as possible to decode HPSs 146D-146E, while directly decoding non-reusable parameters. In this manner, video decoder 30 may optimize the decoding process by reusing pertinent parameters in HPSs 146D-146E, while directly decoding other parameters to maintain accuracy and mitigate decoding errors.

In some example use cases of decoding slice headers 144 according to HPS model 140, video decoder 30 may inherit three initial portions, referred to herein as “parts” 0-2, of slice header 144C from HPS 146D. Video decoder may, in various instances, inherit parts 0-2 from the same portions of HPS 146D, or from different portions of HPS 146D. According to these example use cases, video decoder 30 may inherit a final portion of slice header 144C from HPS 146E. In one such example, video decoder 30 may associate the final portion of slice header 144C as part N+1, indicating that slice header 144C includes one additional part (e.g., parameter) than each of slice headers 144A-144B, which may each include N parts.

Video decoder 30 may decode one or more of parts 0-(N+1) of slice header 144C based on indirect inter-layer dependency. As one example, video decoder 30 may inherit one or more parameters (the “inherited parameters”) from HPS 146 to decode part 0 of slice header 144C. Additionally, video decoder 30 may decode HPS 146 by reusing the inherited parameters from HPS 146A. In this manner, video decoder 30 may indirectly inherit parameters from HPS 146A into slice header 144C, using HPS 146D as a conduit.

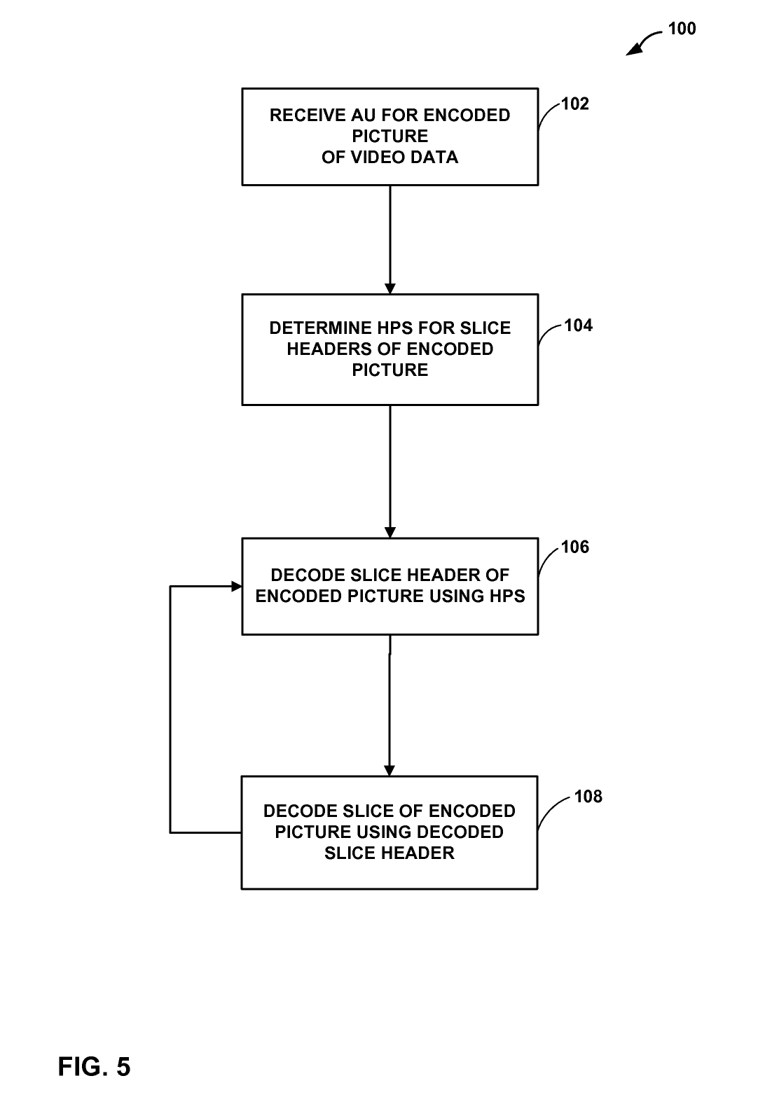

FIG. 5 is a flowchart illustrating an example process 100 that video decoder 30 and/or components thereof may perform to decode encoded video data, in accordance with one or more aspects of this disclosure. Process 100 may begin when video decoder 30 receives an access unit (AU) for an encoded picture of video data (102). For instance, video decoder 30 may receive the encoded AU as part of an encoded bitstream signaled by video encoder 20. Additionally, video decoder 30 may determine a header parameter set (HPS) for one or more slice headers of the encoded picture of the AU (104).

As described, video decoder 30 may use each of the one or more slice headers to decode a slice of the encoded picture. In specific examples, video decoder 30 may use syntax elements, such as syntax elements that specify parameters, of slice header to decode the corresponding slice. Video decoder 30 may decode an HPS to determine one or more parameters to inherit into one or more slice headers of the AU. Additionally, video decoder 30 may determine that the slice headers that are eligible to inherit parameters from a particular HPS of the AU are positioned at an equal or higher layer than the corresponding HPS.

Video decoder 30 may decode a slice header of the encoded picture using one or more signaled HPSs (106). More specifically, video decoder 30 may decode the slice header by inheriting particular parameters from each of the one or more HPSs into the slice header. In examples, video decoder 30 may inherit different portions of the slice header from different HPSs of the AU, and may decode certain portions of the slice header independently of HPS-specified syntax elements.

Video decoder 30 may decode the corresponding slice of the encoded picture using the decoded slice header (108). As described, video decoder 30 may use decoded parameters of the slice header to decode the corresponding slice. Upon decoding the slice, video decoder 30 may decode the next slice header (effectively returning to 106), whether the next slice header belongs to the same picture or a subsequent picture of the encoded bitstream, as the case may be.

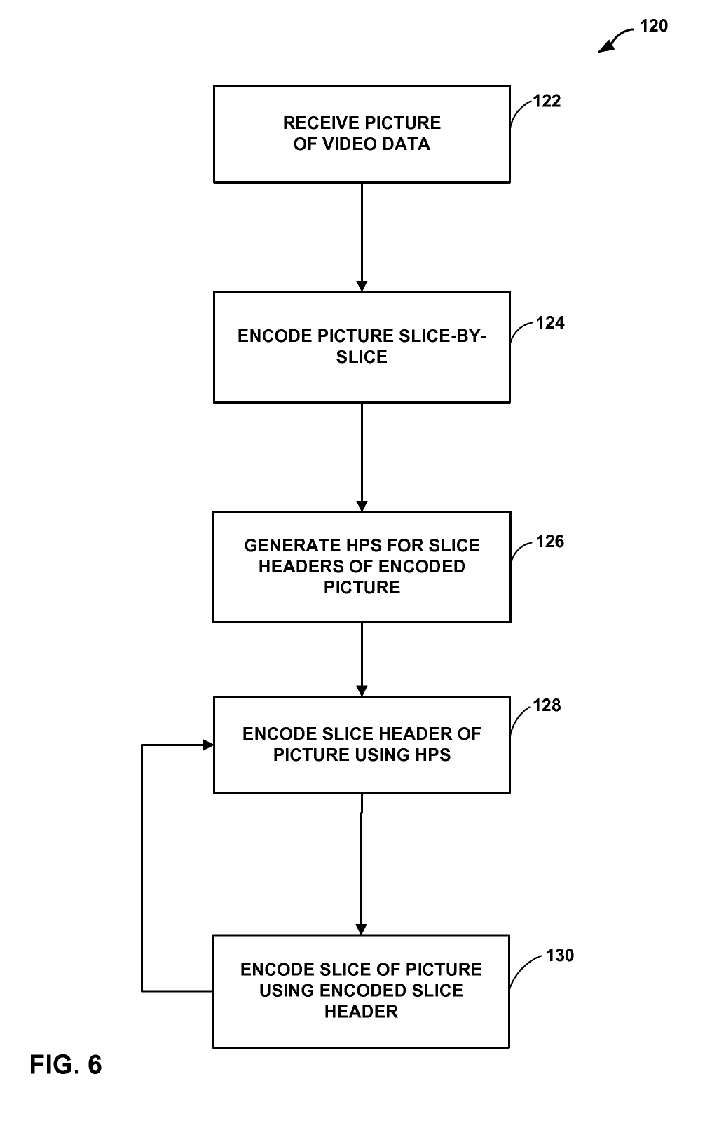

FIG. 6 is a flowchart illustrating an example process 120 that video encoder 20 and/or components thereof may perform to encode video data, in accordance with one or more aspects of this disclosure. Process 120 may begin when video encoder 20 receives a picture of video data (122). For instance, video encoder 20 may receive the picture from video source 18 of source device 12. Additionally, video encoder 20 may encode the picture on a slice-by-slice basis (124).

More specifically, video encoder 20 may divide the encoded picture into a series of encoded blocks. Additionally, video encoder 20 may determine that particular sequences of encoded blocks form a slice of the encoded picture. Video encoder 20 may preface each slice with a slice header, and in examples, may insert an end-of-slice symbol at the end of each slice. Video encoder 20 may include various parameters in the slice header. In turn, video encoder 20 may use one or more of the parameters of the slice header to encode the corresponding slice. Moreover, video encoder 20 may enable a video decoder to decode the slice by using parameters of the corresponding decoded slice header.

Video encoder 20 may generate an HPS for one or more slice headers of the encoded picture (126). For instance, video encoder 20 may generate the HPS to include one or more parameters that are common to multiple slice headers of the encoded picture. In examples, video encoder 20 may generate multiple HPSs for the encoded picture. As an example, video encoder 20 may generate a first HPS that includes parameter values common to a group of slice headers, and may generate a second HPS that includes corresponding parameters, with a different value, that are common to another group of slice headers.

Additionally, video encoder 20 may encode one or more slice headers of the picture using one or more of the generated HPSs (128). As described, video encoder 20 may encode one or more slice headers by inheriting parameter values included in one or more HPSs referenced by the slice headers. In turn, video encoder 20 may encode a current slice of the picture using the corresponding slice header (130). Upon encoding a current slice, video encoder 20 may encode the next slice header, whether the next slice header corresponds to a subsequent slice of the same picture, or to a slice of a subsequent picture, as the case may be.

In this manner, either of video decoder 30 or video encoder 20 may be an example of a device for coding video data, the device including means for determining a header parameter set that includes one or more syntax elements specified individually by each of one or more slice headers, and means for determining the one or more slice headers that reference the header parameter set to inherit at least one of the syntax elements included in the header parameter set, where the slice headers are each associated with a slice of the encoded video data.

Additionally, in this manner, either of destination device 14 or source device 12 may be an example of a computing device that includes or is coupled to a computer-readable storage medium having stored thereon instructions that, when executed, cause a programmable processor of the computing device to determine a header parameter set that includes one or more syntax elements specified individually by each of one or more slice headers, and determine the one or more slice headers that reference the header parameter set to inherit at least one of the syntax elements included in the header parameter set, where the slice headers are each associated with a slice of encoded video data.

In one example of the techniques of this disclosure, video encoder 20 and/or video decoder 30 may determine that a layer may include multiple HPSs, and that, in instances of an HPS including reused data from a reference-HPS, that the HPS may only reuse data from a single reference-HPS. Additionally, video encoder 20 and/or video decoder 30 may determine that the HPS is associated with a NAL unit type reserved in the current HEVC draft specification. Video encoder 20 and/or video decoder 30 may use data represented in syntax table 1 below, to determine an SPS raw byte sequence payload (RBSP) syntax. In syntax table 1 below, underlining denotes changes from (e.g., additions to) the existing syntax, e.g., as included in the current HEVC draft specification.

SYNTAX TABLE 1

| | |
|---|---|
| seq_parameter_set_rbsp( ) { | Descriptor |

| | |
|---|---|
| profile_idc | u(8) |
| reserved_zero_8bits /* equal to 0 */ | u(8) |
| level_idc | u(8) |
| seq_parameter_set_id | ue(v) |
| ... | |
| multiple_hps_enabled_flag | u(1) |
| hps_use_by_multiple_aus_flag | u(1) |
| ... | |

}

SPS RBSP semantics, as included in syntax table 1, are as follows. If the “multiple_hps_enabled_flag” is set to a value equal to 1, then this syntax element may indicate support for a particular AU including more than one HPS, or support for a single layer representation/view component including more than one HPS. On the other hand, if the “multiple_hps_enabled_flag” is set to a value equal to 0, then this syntax element may indicate that, at most, one HPS may be included within a single AU, or within a single layer representation or view component. If the “hps_use_by_multiple_aus_flag” is set to a value equal to 1, then this syntax element may indicate that an HPS may be referred to by coded slices in more than one AU. On the other hand, if the “hps_use_by_multiple_aus_flag” is set to a value equal to 0, then this syntax element may indicate that an HPS may only be referred to by coded slices in, at most, one AU. In some instances, the “multiple_hps_enabled_flag” may be included in the PPS, with the same semantics as above.

Syntax table 2 below illustrates an example of HPS RBSP syntax, with underlining to denote changes from existing syntax.

SYNTAX TABLE 2

| | | De- |
|---|---|---|
| | | scrip- |
| header_parameter_set( ) { | | tor |
| | header_para_set_id | ue(v) |
| | pic_parameter_set_id | ue(v) |
| | rap_pic_flag | u(1) |
| | if( rap_pic_flag ) | |

| | |
|---|---|
| idr_pic_flag | u(1) |

// the ones that do not change among slices
if( !idr_pic_flag ) {

if( !hps_use_by_multiple_aus_flag )

| | |
|---|---|
| pic_order_cnt_lsb | u(v) |

| | |
|---|---|
| short_term_ref_pic_set_sps_flag | u(1) |
| if( !short_term_ref_pic_set_sps_flag ) | |

short_term_ref_pic_set(
num_short_term_ref_pic_sets )

else

| | |
|---|---|
| short_term_ref_pic_set_idx | u(v) |

if( long_term_ref_pics_present_flag ) {

| | |
|---|---|
| num_long_term_pics | ue(v) |
| for( i = 0; i < num_long_term_pics; i++ ) { | |

| | |
|---|---|
| poc_lsb_lt[ i ] | u(v) |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

| | |
|---|---|
| used_by_curr_pic_lt_flag[ i ] | u(1) |

}

}

| | |
|---|---|
| } | |
| slice_type | ue(v) |
| if( output_flag_present_flag ) | |

| | |
|---|---|
| pic_output_flag | u(1) |

if( separate_colour_plane_flag = = 1 )

| | |
|---|---|
| colour_plane_id | u(2) |

if( rap_pic_flag ) {

if( !hps_use_by_multiple_aus_flag )

| | |
|---|---|
| rap_pic_id | ue(v) |

| | |
|---|---|
| no_output_of_prior_pics_flag | u(1) |

}

// above are the info. that is typically shared by all HPSs of a layer
of an AU

if( adaptive_loop_filter_enabled_flag )

| | |
|---|---|
| aps_id | ue(v) |

// RPL or info. related to RPL

if( slice_type = = P | | slice_type = = B ) {

if( sps_temporal_mvp_enable_flag )

| | |
|---|---|
| pic_temporal_mvp_enable_flag | u(1) |

| | |
|---|---|
| num_ref_idx_active_override_flag | u(1) |
| if( num_ref_idx_active_override_flag ) { | |

| | |
|---|---|
| num_ref_idx_l0_active_minus1 | ue(v) |
| if( slice_type = = B ) | |

| | |
|---|---|
| num_ref_idx_l1_active_minus1 | ue(v) |

}

}
if( lists_modification_present_flag )

ref_pic_list_modification( )

if( slice_type = = B )

| | |
|---|---|
| mvd_l1_zero_flag | u(1) |

if( pic_temporal_mvp_enable_flag ) {

if( slice_type = = B )

| | |
|---|---|
| collocated_from_l0_flag | u(1) |

if( slice_type != I &&

((collocated_from_l0_flag &&
num_ref_idx_l0_active_minus1 > 0) | |

```
  (!collocated_from_l0_flag &&
  num_ref_idx_l1_active_minus1 > 0) )
```

| | |
|---|---|
| collocated ref_idx | ue(v) |

}
if( slice_type = = P | | slice_type = = B )

| | |
|---|---|
| five_minus_max_num_merge_cand | ue(v) |

// prediction weights

if( ( weighted_pred_flag && slice_type = = P) | |

```
  ( weighted_bipred_idc = = 1 && slice_type = =
  B ) )
pred_weight_table( )
```

//deblocking

if( deblocking_filter_control_present_flag ) {

if( deblocking_filter_override_enabled_flag )

| | |
|---|---|
| deblocking_filter_override_flag | u(1) |

if( deblocking_filter_override_flag ) {

| | |
|---|---|
| slice_header_disable_deblocking_filter_flag | u(1) |
| if( !slice_header_disable_deblocking_filter_flag | |
| ) { | |

| | |
|---|---|
| beta_offset_div2 | se(v) |
| tc_offset_div2 | se(v) |

}

}

}

// other info. that may not be common but don't need to predict

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |

( slice_adaptive_loop_filter_flag | |
slice_sample_adaptive_offset_flag | |

!disable_deblocking_filter_flag ) )

| | |
|---|---|
| slice_loop_filter_across_slices_enabled_flag | u(1) |

| | |
|---|---|
| } | |
| hps_extension_flag | u(1) |
| if( hps_extension_flag ) | |

while( more_rbsp_data( ) )

| | |
|---|---|
| hps_extension_data_flag | u(1) |

}

An alternative arrangement of syntax table 2 is illustrated in syntax table 2a below.

SYNTAX TABLE 2a

| | | De- |
|---|---|---|
| | | scrip- |
| header_parameter_set( ) { | | tor |
| | header_para_set_id | ue(v) |
| | if( multiple_hps_enabled_flag ) | |

| | |
|---|---|
| common_info_present_flag | u(1) |

if (common_info_present_flag)

common_info_table( )

// above are the info. that is typically shared by all HPSs of a layer
of an AU

if( multiple_hps_enabled_flag )

| | |
|---|---|
| ref_pic_list_related_info_present_flag | u(1) |

if ( ref_pic_list_related_info_present_flag )

reference_pic_related_info_table( )

// prediction weights

if( ( weighted_pred_flag && slice_type = = P) | |

```
  ( weighted_bipred_idc = = 1 && slice_type = =
  B ) )
```

{

if( multiple_hps_enabled_flag )

| | |
|---|---|
| pred_weight_table_present_flag | u(1) |

if (pred_weight_table_present_flag )

pred_weight_table( )

}

//deblocking

if ( deblocking_filter_control_present_flag ) {

if( multiple_hps_enabled_flag )

| | |
|---|---|
| deblocking_para_table_present_flag | u(1) |

if (deblocking_para_table_present_flag)

deblocking_para_table( )

}

// other info. that may or may not be common but don't need to
be put in as a new category to be predicted.

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |

( slice_adaptive_loop_filter_flag | |
slice_sample_adaptive_offset_flag | |

!disable_deblocking_filter_flag ) )

| | |
|---|---|
| slice_loop_filter_across_slices_enabled_flag | u(1) |

}
if(adaptive_loop_filter_enabled_flag )

| | |
|---|---|
| aps_id | ue(v) |

// extension ...

| | |
|---|---|
| hps_extension_flag | u(1) |
| if( hps_extension_flag ) | |

while( more_rbsp_data( ) )

| | |
|---|---|
| hps_extension_data_flag | u(1) |

| } | | |
|---|---|---|
| | | De- |
| | | scrip- |
| common_info_table( ) { | | tor |
| | pic_parameter_set_id | ue(v) |
| | if( !IdrPicFlag ) { | |

| | |
|---|---|
| pic_order_cnt_lsb | u(v) |
| short_term_ref_pic_set_sps_flag | u(1) |
| if( !short_term_ref_pic_set_sps_flag ) | |

short_term_ref_pic_set(
num_short_term_ref_pic_sets )

else

| | |
|---|---|
| short_term_ref_pic_set_idx | u(v) |

if( long_term_ref_pics_present_flag ) {

| | |
|---|---|
| num_long_term_pics | ue(v) |
| for( I = 0; I < num_long_term_pics; i++ ) { | |

| | |
|---|---|
| poc_lsb_lt[ I ] | u(v) |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

| | |
|---|---|
| used_by_curr_pic_lt_flag[ I ] | u(1) |

}

}

| | |
|---|---|
| } | |
| slice_type | ue(v) |
| if( output_flag_present_flag ) | |

| | |
|---|---|
| pic_output_flag | u(1) |

if( separate_colour_plane_flag = = 1 )

| | |
|---|---|
| colour_plane_id | u(2) |

if( RapPicFlag ) {

| | |
|---|---|
| rap_pic_id | ue(v) |
| no_output_of_prior_pics_flag | u(1) |

}

| } | |
|---|---|
| | De- |
| | scrip- |
| reference_pic_related_info_table ( ){ | tor |

if( slice_type = = P | | slice_type = = B ) {

if( sps_temporal_mvp_enable_flag )

| | |
|---|---|
| pic_temporal_mvp_enable_flag | u(1) |

| | |
|---|---|
| num_ref_idx_active_override_flag | u(1) |
| if( num_ref_idx_active_override_flag ) { | |

| | |
|---|---|
| num_ref_idx_l0_active_minus1 | ue(v) |
| if( slice_type = = B ) | |

| | |
|---|---|
| num_ref_idx_l1_active_minus1 | ue(v) |

}

}
if( lists_modification_present_flag )

ref_pic_list_modification( )

if( slice_type = = B )

| | |
|---|---|
| mvd_l1_zero_flag | u(1) |
| if( pic_temporal_mvp_enable_flag ) { | |

if( slice_type = = B )

| | |
|---|---|
| collocated_from_l0_flag | u(1) |

if( slice_type != I &&

| | |
|---|---|
| ((collocated_from_l0_flag && | |
| num_ref_idx_l0_active_minus1 > 0) \| \| | |
| (!collocated_from_l0_flag && | |
| num_ref_idx_l1_active_minus1 > 0) ) | |
| collocated_ref_idx | ue(v) |

}
if( slice_type = = P | | slice_type = = B )

| | |
|---|---|
| five_minus_max_num_merge_cand | ue(v) |

| } | |
|---|---|
| | De- |
| | scrip- |
| deblocking_para_table( ){ | tor |

if( deblocking_filter_override_enabled_flag )

| | |
|---|---|
| deblocking_filter_override_flag | u(1) |

if( deblocking_filter_override_flag ) {

| | |
|---|---|
| slice_header_disable_deblocking_filter_flag | u(1) |
| if( !slice_header_disable_deblocking_filter_flag ) { | |

| | |
|---|---|
| beta_offset_div2 | se(v) |
| tc_offset_div2 | se(v) |

}

}

}

Semantics of the HPS RBSP may be as follows. The semantics of a syntax element, if currently present in slice header in the latest HEVC draft specification, may remain the same as specified in the latest HEVC draft specification. The “header_para_set_id” identifies an HPS, within a particular layer. The “common_info_present_flag,” if set to a value equal to 1, may indicate that the common_info_table( ) is present in the current HPS. On the other hand, if “common_info_present_flag” is set equal to 0, this syntax element may indicate that the common_info_table( ) is not present in the current HPS. When not present, video encoder 20 and/or video decoder 30 may infer the value of this syntax element to be equal to 1.

The “ref_pic_list_related_info_present_flag,” if set equal to 1, may indicate that the reference_pic_related_info_table( ) is included in the current HPS. Conversely, if “ref_pic_list_related_info_present_flag” is set equal to 0, this syntax element may indicate that the reference_pic_related_info_table( ) is not included in the current HPS. When not present, video encoder 20 and/or video decoder 30 may infer the value of this syntax element to be equal to 1. The “pred_weight_table_present_flag,” if set equal to 1, may indicate that the pred_weight_table( ) is present in the current HPS, and conversely, if the pred_weight_table_present_flag is set equal to 0, this syntax element may indicate that the pred_weight_table( ) is not present in the HPS. When not present, video encoder 20 and/or video decoder 30 may infer the value of this syntax element to be equal to 1.

If the “deblocking_para_table_present_flag” is set equal to 1, this syntax element may specify that the deblocking_para_table( ) is present in the current HPS. On the other hand, if the deblocking_para_table_present_flag is to a value equal to 0, this syntax element may indicate that the deblocking_para_table( ) is not present in the current HPS. When not present, video encoder 20 and/or video decoder 30 may infer the value of this syntax element to be equal to 1. If the “hps_extension_flag” is set equal to 0, this syntax element may indicate that no hps_extension_data_flag syntax elements are present in the RBSP syntax structure. If the hps_extension_flag is set equal to 1, video decoder 30 may disregard all data that follow the value 1 for hps_extension_flag in a NAL unit. The value of the “hps_extension_data_flag” may not affect the conformance of video decoder 30 to the techniques of this disclosure.

An HPS syntax table and the corresponding common syntax table, in accordance with certain examples of the techniques described herein, are illustrated in syntax tables 3 and 3a below.

SYNTAX TABLE 3

| | | De- |
|---|---|---|
| | | scrip- |
| header_parameter_set( ) { | | tor |
| | header_para_set_id | ue(v) |
| | slice_type | ue(v) |
| | if( multiple_hps_enabled_flag ) | |

| | |
|---|---|
| common_info_present_flag | u(1) |

if( common_info_present_flag )

common_info_table( 1 )

// above are the info. that is typically shared by all HPSs of a layer
of an AU

if( multiple_hps_enabled_flag )

| | |
|---|---|
| ref_pic_list_related_info_present_flag | u(1) |

if( ref_pic_list_related_info_present_flag )

reference_pic_related_info_table( )

// prediction weights

if( ( weighted_pred_flag && slice_type = = P) | |

```
  ( weighted_bipred_idc = = 1 && slice_type = =
  B ) )
```

{

if( multiple_hps_enabled_flag )

| | |
|---|---|
| pred_weight_table_present_flag | u(1) |

if (pred_weight_table_present_flag )

pred_weight_table( )

}

//deblocking

if ( deblocking_filter_control_present_flag ) {

if( multiple_hps_enabled_flag )

| | |
|---|---|
| deblocking_para_table_present_flag | u(1) |

if (deblocking_para_table_present_flag)

deblocking_para_table( )

}

// other info. that may or may not be common, or may be common
for a subset of slices in a picture, but don't need to be put in
as a new category to be separately predicted.

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |

( slice_adaptive_loop_filter_flag | |
slice_sample_adaptive_offset_flag | |

!disable_deblocking_filter_flag ) )

| | |
|---|---|
| slice_loop_filter_across_slices_enabled_flag | u(1) |

if( adaptive_loop_filter_enabled_flag )

| | |
|---|---|
| aps_id | ue(v) |

if( separate_colour_plane_flag = = 1 )

| | |
|---|---|
| colour_plane_id | u(2) |

// extension ...

| | |
|---|---|
| hps_extension_flag | u(1) |
| if( hps_extension_flag ) | |

while( more_rbsp_data( ) )

| | |
|---|---|
| hps_extension_data_flag | u(1) |

}

SYNTAX TABLE 3a

| | |
|---|---|
| | De- |
| | scrip- |
| common_info_table( inHpsFlag ) { | tor |

if( inHpsFlag ) {

| | |
|---|---|
| rap_pic_flag | u(1) |
| if( rap_pic_flag ) | |

| | |
|---|---|
| idr_pic_flag | u(1) |

| | |
|---|---|
| } | |
| pic_parameter_set_id | ue(v) |
| if( !hpsIdrPicFlag ) { | |

if( !hps_use_by_multiple_aus_flag )

| | |
|---|---|
| pic_order_cnt_lsb | u(v) |

| | |
|---|---|
| short_term_ref_pic_set_sps_flag | u(1) |
| if( !short_term_ref_pic_set_sps_flag ) | |

short_term_ref_pic_set(
num_short_term_ref_pic_sets )

else

| | |
|---|---|
| short_term_ref_pic_set_idx | u(v) |

if( long_term_ref_pics_present_flag ) {

| | |
|---|---|
| num_long_term_pics | ue(v) |
| for( i = 0; i < num_long_term_pics; i++ ) { | |

| | |
|---|---|
| poc_lsb_lt[ I ] | u(v) |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

| | |
|---|---|
| used_by_curr_pic_lt_flag[ I ] | u(1) |

}

}

}
if( output_flag_present_flag )

| | |
|---|---|
| pic_output_flag | u(1) |

if( hpsRapPicFlag ) {

if( !hps_use_by_multiple_aus_flag )

| | |
|---|---|
| rap_pic_id | ue(v) |

| | |
|---|---|
| no_output_of_prior_pics_flag | u(1) |

}

}

The semantics of HPS RBSP for syntax tables 3 and 3a may be the same as the semantics described above with respect to syntax tables 1-2a, but may also include additional semantics as follows. The “rap_pic_flag” may specify the value of the variable hpsRapPicFlag. The value of rap_pic_flag may be equal to RapPicFlag of the coded slice NAL unit referring to the HPS that includes the common_info_table( ) syntax structure. Video encoder 20 and/or video decoder 30 may derive the value of hpsRapPicFlag as follows. If rap_pic_flag is present, video encoder 20 and/or video decoder 30 may set the value of hpsRapPicFlag to be equal to rap_pic_flag. Otherwise, if rap_pic_flag is not present, video encoder 20 and/or video decoder 30 may set the value of rap_pic_flag to equal the RapPicFlag value of the coded slice NAL unit for which the slice header includes the common_info_table( ) syntax structure.

The “idr_pic_flag” may indicate the value of the variable hpsIdrPicFlag. Video encoder 20 and/or video decoder 30 may set the value of idr_pic_flag to be equal to IdrPicFlag of the coded slice NAL unit referring to the HPS that contains the common_info_table( ) syntax structure. If rap_pic_flag is present and the value is equal to 0, video decoder 30 may infer the value of idr_pic_flag to be equal to 0. Video encoder 20 and/or video decoder 30 may derive the value of hpsIdrPicFlag as follows. If rap_pic_flag is present, video encoder 20 and/or video decoder 30 may set the value of hpsIdrPicFlag to be equal to the value of idr_pic_flag. On the other hand, if rap_pic_flag is not present, video encoder 20 and/or video decoder 30 may set the value of idr_pic_flag is set to be equal to IdrPicFlag of the coded slice NAL unit for which the slice header includes the common_info_table( ) syntax structure.

In accordance with examples conforming to the semantics described above with respect to syntax tables 3 and 3a, slice header syntax may be specified in accordance with syntax table 4 below. Underlining in syntax table 4 indicates changes from existing slice header syntax.

SYNTAX TABLE 4

| slice_header( ) { | | Descriptor |
|---|---|---|
| | slice_address | ue(v) |
| | common_info_HPS_id | ue(v) |
| | if (!multiple_hps_enabled_flag) | |

| | |
|---|---|
| prediction_from_one_HPS_flag | u(1) |

if( !prediction_from_one_HPS_flag ) {

| | |
|---|---|
| reference_pic_related_info_HPS_id | ue(v) |
| if( ( weighted_pred_flag && slice_type = = P) \| \| | |
| ( weighted_bipred_idc = = 1 && slice_type = = B ) ) | |

| | |
|---|---|
| pred_weight_table_HPS_id | ue(v) |

if ( deblocking_filter_control_present_flag )

| | |
|---|---|
| deblocking_para_table_HPS_id | ue(v) |

}
if( dependent_slice_enabled_flag )

| | |
|---|---|
| dependent_slice_flag | u(1) |

if( adaptive_loop_filter_enabled_flag ) {

| | |
|---|---|
| slice_adaptive_loop_filter_flag | u(1) |
| if( slice_adaptive_loop_filter_flag && alf_coef_in_slice_flag ) | |

alf_param( )

if( slice_adaptive_loop_filter_flag && !alf_coef_in_slice_flag )

alf_cu_control_param( )

}
if( sample_adaptive_offset_enabled_flag ) {

| | |
|---|---|
| slice_sample_adaptive_offset_flag[ 0 ] | u(1) |
| if( slice_sample_adaptive_offset_flag[ 0 ] ) { | |

| | |
|---|---|
| slice_sample_adaptive_offset_flag[ 1 ] | u(1) |
| slice_sample_adaptive_offset_flag[ 2 ] | u(1) |

}

| | |
|---|---|
| } | |
| other_info_override_flag | u(1) |
| if (other_info_override_flag) { | |

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |
| ( slice_adaptive_loop_filter_flag \| \| slice_sample_adaptive_offset_flag \| \| | |

| | |
|---|---|
| !disable_deblocking_filter_flag ) ) | |
| slice_loop_filter_across_slices_enabled_flag | u(1) |

}
if(adaptive_loop_filter_enabled_flag )

| | |
|---|---|
| aps_id | ue(v) |

}
if( tiles_or_entropy_coding_sync_idc = = 1 | |

| | |
|---|---|
| tiles_or_entropy_coding_sync_idc = = 2 ) { | |
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_header_extension_present_flag ) {

| | |
|---|---|
| slice_header_extension_length | ue(v) |
| for( i = 0; i < slice_header_extension_length; i++) | |

| | |
|---|---|
| slice_header_extension_data_byte | u(8) |

}

}

An alternative set of slice header syntax is illustrated in syntax table 4a below.

SYNTAX TABLE 4a

| slice_header( ) { | | Descriptor |
|---|---|---|
| | slice_address | ue(v) |
| | if( slice_address != 0 ) | |

| | |
|---|---|
| dependent_slice_flag | u(1) |

if( !dependent_slice_flag ) {

| | |
|---|---|
| common_info_hps_id | ue(v) |

if( hps_use_by_multiple_aus_flag ){

| | |
|---|---|
| pic_order_cnt_lsb | u(v) |
| if( RapPicFlag ) | |

| | |
|---|---|
| rap_pic_id | ue(v) |

}

| | |
|---|---|
| other_info_override_flag | u(1) |
| if( other_info_override_flag ) { | |

| | |
|---|---|
| slice_type | ue(v) |
| if( cabac_init_present_flag && slice_type != I ) | |

| | |
|---|---|
| cabac_init_flag | u(1) |

| | |
|---|---|
| slice_qp_delta | se(v) |

if( adaptive_loop_filter_enabled_flag )

| | |
|---|---|
| aps_id | ue(v) |

if( separate_colour_plane_flag = = 1 )

| | |
|---|---|
| colour_plane_id | u(2) |

}
if( !multiple_hps_enabled_flag )

| | |
|---|---|
| prediction_from_one_hps_flag | u(1) |

if( !prediction_from_one_hps_flag ) {

| | |
|---|---|
| reference_pic_related_info_hps_id | ue(v) |
| if( ( weighted_pred_flag && slice_type = = P) \| \| | |
| ( weighted_bipred_idc = = 1 && slice_type = = B ) ) | |

| | |
|---|---|
| pred_weight_table_hps_id | ue(v) |

if ( deblocking_filter_control_present_flag )

| | |
|---|---|
| deblocking_para_table_hps_id | ue(v) |

}
if( other_info_override_flag )

if( seq_loop_filter_across_slices_enabled_flag &&
( slice_adaptive_loop_filter_flag | | slice_sample_adaptive_offset_flag | |

| | |
|---|---|
| !slice_header_disable_deblocking_filter_flag ) ) | |
| slice_loop_filter_across_slices_enabled_flag | u(1) |

if( adaptive_loop_filter_enabled_flag ) {

| | |
|---|---|
| slice_adaptive_loop_filter_flag | u(1) |
| if( slice_adaptive_loop_filter_flag && alf_coef_in_slice_flag ) | |

alf_param( )

if( slice_adaptive_loop_filter_flag && !alf_coef_in_slice_flag )

alf_cu_control_param( )

}
if( sample_adaptive_offset_enabled_flag ) {

| | |
|---|---|
| slice_sample_adaptive_offset_flag[ 0 ] | u(1) |
| if( slice_sample_adaptive_offset_flag[ 0 ] ) { | |

| | |
|---|---|
| slice_sample_adaptive_offset_flag[ 1 ] | u(1) |
| slice_sample_adaptive_offset_flag[ 2 ] | u(1) |

}

}

}
if( tiles_or_entropy_coding_sync_idc = = 1 | |

| | |
|---|---|
| tiles_or_entropy_coding_sync_idc = = 2 ) { | |
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_header_extension_present_flag ) {

| | |
|---|---|
| slice_header_extension_length | ue(v) |
| for( i = 0; i < slice_header_extension_length; i++) | |

| | |
|---|---|
| slice_header_extension_data_byte | u(8) |

}

}

Yet another alternative of slice header syntax is illustrated in syntax table 4b below.

| slice_header( ) { | | Descriptor |
|---|---|---|
| | slice_address | ue(v) |
| | if( slice_address = = 0 ) | |

| | |
|---|---|
| single_slice_no_hps_flag | u(1) |

else

| | |
|---|---|
| dependent_slice_flag | u(1) |

if( single_slice_no_hps_flag && !dependent_slice_flag ) {

| | |
|---|---|
| slice_type | ue(v) |
| common_info_table( 0 ) | |
| if( hps_use_by_multiple_aus_flag ) | |

| | |
|---|---|
| pic_order_cnt_lsb | u(v) |

if( !hps_use_by_multiple_aus_flag && RapPicFlag )

| | |
|---|---|
| rap_pic_id | ue(v) |

reference_pic_related_info_table( )
if( ( weighted_pred_flag && slice_type = = P) | |

( weighted_bipred_idc = = 1 && slice_type = = B ) )
pred_weight_table( )

if ( deblocking_filter_control_present_flag )

deblocking_para_table( )

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |
| ( slice_adaptive_loop_filter_flag \| \| slice_sample_adaptive_offset_flag \| \| | |

| | |
|---|---|
| !disable_deblocking_filter_flag ) ) | |
| slice_loop_filter_across_slices_enabled_flag | u(1) |

}
if(adaptive_loop_filter_enabled_flag )

| | |
|---|---|
| aps_id | ue(v) |

} else if( !dependent_slice_flag ) {

| | |
|---|---|
| other_info_override_flag | u(1) |
| if (other_info_override_flag ) { | |

| | |
|---|---|
| slice_type | ue(v) |

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |

( slice_adaptive_loop_filter_flag | | slice_sample_adaptive_offset_flag | |

!disable_deblocking_filter_flag ) )

| | |
|---|---|
| slice_loop_filter_across_slices_enabled_flag | u(1) |

if( adaptive_loop_filter_enabled_flag )

| | |
|---|---|
| aps_id | ue(v) |

| | |
|---|---|
| } | |
| common_info_hps_id | ue(v) |
| if( hps_use_by_multiple_aus_flag ){ | |

| | |
|---|---|
| pic_order_cnt_lsb | u(v) |
| if( RapPicFlag ) | |

| | |
|---|---|
| rap_pic_id | ue(v) |

}
if (!multiple_hps_enabled_flag)

| | |
|---|---|
| prediction_from_one_hps_flag | u(1) |

if( !prediction_from_one_hps_flag ) {

| | |
|---|---|
| reference_pic_related_info_hps_id | ue(v) |
| if( ( weighted_pred_flag && slice_type = = P) \| \| | |
| ( weighted_bipred_idc = = 1 && slice_type = = B ) ) | |

| | |
|---|---|
| pred_weight_table_hps_id | ue(v) |

if ( deblocking_filter_control_present_flag )

| | |
|---|---|
| deblocking_para_table_hps_id | ue(v) |

}

}
if( !dependent_slice_flag ) {

if( adaptive_loop_filter_enabled_flag ) {

| | |
|---|---|
| slice_adaptive_loop_filter_flag | u(1) |
| if( slice_adaptive_loop_filter_flag && alf_coef_in_slice_flag ) | |

alf_param( )

if( slice_adaptive_loop_filter_flag && !alf_coef_in_slice_flag )

alf_cu_control_param( )

}
if( sample_adaptive_offset_enabled_flag ) {

| | |
|---|---|
| slice_sample_adaptive_offset_flag[ 0 ] | u(1) |
| if( slice_sample_adaptive_offset_flag[ 0 ] ) { | |

| | |
|---|---|
| slice_sample_adaptive_offset_flag[ 1 ] | u(1) |
| slice_sample_adaptive_offset_flag[ 2 ] | u(1) |

}

}

}
if( tiles_or_entropy_coding_sync_idc = = 1 | |

| | |
|---|---|
| tiles_or_entropy_coding_sync_idc = = 2 ) { | |
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_header_extension_present_flag ) {

| | |
|---|---|
| slice_header_extension_length | ue(v) |
| for( i = 0; i < slice_header_extension_length; i++) | |

| | |
|---|---|
| slice_header_extension_data_byte | u(8) |

}

}

Still another alternative of slice header syntax is illustrated in syntax table 4c below.

SYNTAX TABLE 4c

| | | De- |
|---|---|---|
| | | scrip- |
| slice_header( ) { | | tor |
| | slice_address | ue(v) |
| | if( slice_address = = 0 ) | |

| | |
|---|---|
| single_slice_no_hps_flag | u(1) |

else

| | |
|---|---|
| dependent_slice_flag | u(1) |

if( !single_slice_no_hps_flag &&
!dependent_slice_flag )

| | |
|---|---|
| other_info_override_flag | u(1) |

if( ( single_slice_no_hps_flag | |
other_info_override_flag )

| | |
|---|---|
| && !dependent_slice_flag ) | |
| slice_type | ue(v) |

if( single_slice_no_hps_flag &&
!dependent_slice_flag ){

```
common_info_table(0 )
reference_pic_related_info_table ( )
if( ( weighted_pred_flag && slice_type = = P) | |
  ( weighted_bipred_idc = = 1 && slice_type = =
  B ) )
```

pred_weight_table( )

if ( deblocking_filter_control_present_flag )

deblocking_para_table( )

}
if( ( single_slice_no_hps_flag | |
other_info_override_flag )

&& !dependent_slice_flag ) {
if( cabac_init_present_flag && slice_type != I )

| | |
|---|---|
| cabac_init_flag | u(1) |

| | |
|---|---|
| slice_qp_delta | se(v) |
| if( adaptive_loop_filter_enabled_flag ) | |

| | |
|---|---|
| aps_id | ue(v) |

}
if( !single_slice_no_hps_flag &&
!dependent_slice_flag ) {

| | |
|---|---|
| common_info_hps_id | ue(v) |
| if (!multiple_hps_enabled_flag) | |

| | |
|---|---|
| prediction_from_one_hps_flag | u(1) |

if( !prediction_from_one_hps_flag ) {

| | |
|---|---|
| reference_pic_related_info_hps_id | ue(v) |
| if( ( weighted_pred_flag && slice_type = = | |
| P) \| \| | |
| ( weighted_bipred_idc = = 1 && | |
| slice_type = = B ) ) | |

| | |
|---|---|
| pred_weight_table_hps_id | ue(v) |

if ( deblocking_filter_control_present_flag )

| | |
|---|---|
| deblocking_para_table_hps_id | ue(v) |

}

}
if( hps_use_by_multiple_aus_flag ){

| | |
|---|---|
| pic_order_cnt_lsb | u(v) |
| if( RapPicFlag ) | |

| | |
|---|---|
| rap_pic_id | ue(v) |

}
if( !dependent_slice_flag ) {

if( adaptive_loop_filter_enabled_flag ) {

| | |
|---|---|
| slice_adaptive_loop_filter_flag | u(1) |
| if( slice_adaptive_loop_filter_flag && | |
| alf_coef_in_slice_flag ) | |

alf_param( )

if( slice_adaptive_loop_filter_flag &&
!alf_coef_in_slice_flag )

slice_header_alf_cu_control_param( )

}
if( sample_adaptive_offset_enabled_flag ) {

| | |
|---|---|
| slice_sample_adaptive_offset_flag[ 0 ] | u(1) |
| if( slice_sample_adaptive_offset_flag[ 0 ] | |
| ) { | |

| | |
|---|---|
| slice_sample_adaptive_offset_flag[ 1 ] | u(1) |
| slice_sample_adaptive_offset_flag[ 2 ] | u(1) |

}

}

}
if( ( single_slice_no_hps_flag | |
other_info_override_flag )

&& !dependent_slice_flag &&
seq_loop_filter_across_slices_enabled_flag &&
( slice_adaptive_loop_filter_flag | |
slice_sample_adaptive_offset_flag[ 0 ] | |

!slice_heder_disable_deblocking_filter_flag
)

)

| | |
|---|---|
| slice_loop_filter_across_slices_enabled_flag | u(1) |

if( tiles_or_entropy_coding_sync_idc = = 1 | |

| | |
|---|---|
| tiles_or_entropy_coding_sync_idc = = 2 ) { | |
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_header_extension_present_flag ) {

| | |
|---|---|
| slice_header_extension_length | ue(v) |
| for( i = 0; i < slice_header_extension_length; i++) | |

| | |
|---|---|
| slice_header_extension_data_byte | u(8) |

}

}

Yet another alternative of slice header syntax is illustrated in syntax table 4d below.

SYNTAX TABLE 4d

| | | De- |
|---|---|---|
| | | scrip- |
| slice_header( ) { | | tor |
| | slice_address | ue(v) |
| | if( slice_address = = 0 ) | |

| | |
|---|---|
| single_slice_no_hps_flag | u(1) |

else

| | |
|---|---|
| dependent_slice_flag | u(1) |

if( !single_slice_no_hps_flag &&
!dependent_slice_flag )

| | |
|---|---|
| other_info_override_flag | u(1) |

if( ( single_slice_no_hps_flag | |
other_info_override_flag )

| | |
|---|---|
| && !dependent_slice_flag ) | |
| slice_type | ue(v) |

if(!dependent_slice_flag ) {

if (single_slice_no_hps_flag )

common_info_table(0 )

| | |
|---|---|
| else | |
| common_info_hps_id | ue(v) |

}
if( hps_use_by_multiple_aus_flag ){

| | |
|---|---|
| pic_order_cnt_lsb | u(v) |
| if( RapPicFlag ) | |

| | |
|---|---|
| rap_pic_id | ue(v) |

}

if( single_slice_no_hps_flag && !dependent_slice_flag ){

```
reference_pic_related_info_table ( )
if( ( weighted_pred_flag && slice_type = = P) | |
  ( weighted_bipred_idc = = 1 && slice_type = =
  B ) )
```

pred_weight_table( )

if ( deblocking_filter_control_present_flag )

deblocking_para_table( )

}
if( ( single_slice_no_hps_flag | |
other_info_override_flag )

&& !dependent_slice_flag ) {
if( cabac_init_present_flag && slice_type != I )

| | |
|---|---|
| cabac_init_flag | u(1) |

| | |
|---|---|
| slice_qp_delta | se(v) |
| if( adaptive_loop_filter_enabled_flag ) | |

| | |
|---|---|
| aps_id | ue(v) |

}
if( !single_slice_no_hps_flag &&
!dependent_slice_flag) {

if (!multiple_hps_enabled_flag)

| | |
|---|---|
| prediction_from_one_hps_flag | u(1) |

if( !prediction_from_one_hps_flag ) {

| | |
|---|---|
| reference_pic_related_info_hps_id | ue(v) |
| if( ( weighted_pred_flag && slice_type = = | |
| P) \| \| | |
| ( weighted_bipred_idc = = 1 && | |
| slice_type = = B ) ) | |

| | |
|---|---|
| pred_weight_table_hps_id | ue(v) |

if ( deblocking_filter_control_present_flag )

| | |
|---|---|
| deblocking_para_table_hps_id | ue(v) |

}

}
if( !dependent_slice_flag ) {

if( adaptive_loop_filter_enabled_flag ) {

| | |
|---|---|
| slice_adaptive_loop_filter_flag | u(1) |
| if( slice_adaptive_loop_filter_flag && | |
| alf_coef_in_slice_flag ) | |

alf_param( )

if( slice_adaptive_loop_filter_flag &&
!alf_coef_in_slice_flag )

slice_header_alf_cu_control_param( )

}
if( sample_adaptive_offset_enabled_flag ) {

| | |
|---|---|
| slice_sample_adaptive_offset_flag[ 0 ] | u(1) |
| if( slice_sample_adaptive_offset_flag[ 0 ] | |
| ) { | |

| | |
|---|---|
| slice_sample_adaptive_offset_flag[ 1 ] | u(1) |
| slice_sample_adaptive_offset_flag[ 2 ] | u(1) |

}

}

}
if( ( single_slice_no_hps_flag | |
other_info_override_flag )

&& !dependent_slice_flag &&
seq_loop_filter_across_slices_enabled_flag &&
( slice_adaptive_loop_filter_flag | |
slice_sample_adaptive_offset_flag[ 0 ] | |

!slice_heder_disable_deblocking_filter_flag
)

)

| | |
|---|---|
| slice_loop_filter_across_slices_enabled_flag | u(1) |

if( tiles_or_entropy_coding_sync_idc = = 1 | |

| | |
|---|---|
| tiles_or_entropy_coding_sync_idc = = 2 ) { | |
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_header_extension_present_flag ) {

| | |
|---|---|
| slice_header_extension_length | ue(v) |
| for( i = 0; i < slice_header_extension_length; i++) | |

| | |
|---|---|
| slice_header_extension_data_byte | u(8) |

}

}

Slice header semantics may be specified as follows for syntax elements that are indicated as newly added in syntax tables 4-4d. The “single_slice_no_hps_flag,” if set equal to 1, may indicate that the current picture includes only one slice, and that all slice header parameters for the single slice are directly included in the slice header. On the other hand, if the single_slice_no_hps_flag is set equal to 0, this syntax element may specify that the current picture may consist of multiple slices, and that one or more slice header parameters may be inherited from one or more HPSs. If the “prediction_from_one_hps_flag” is set equal to 1, this syntax element may specify that the current slice header includes data inherited from only one HPS. If the prediction_from_one_HPS_flag is set equal to 0, this syntax element may specify that the current slice header may include data that is inherited from multiple HPSs. When not present, video encoder 20 and/or video decoder 30 may infer the value of this syntax element to be equal to 1.

The “common_info_hps_id” may identify the HPS used to inherit the syntax elements in the common_info_table( ) for the current slice header. The “reference_pic_related_info_hps_id” may identify the HPS used to inherit the syntax elements in the reference_pic_related_info_table( ) for the current slice header. If not present, video encoder 20 and/or video decoder 30 may infer the value of this syntax element to be equal to common_info_HPS_id. The “pred_weight_table_hps_id” may identify the HPS used to inherit the syntax elements in the pred_weight_table( ) for the current slice header. If not present, video encoder 20 and/or video decoder 30 may infer the value of this syntax element to be equal to common_info_HPS_id.

The “deblocking_para_table_hps_id” may identify the HPS used to inherit the syntax elements in the deblocking_para_table( ) for the current slice header. When not present, video encoder 20 and/or video decoder 30 may infer the value of this syntax element to be equal to common_info_HPS_id. Video decoder 30 may determine that the “other_info_override_flag,” if set equal to 1, indicates that other syntax elements, including the cabac_init_flag, the slice_qp_delta, slice_loop_filter_across_slices_enabled_flag, and the aps_id in the slice header are signalled in the slice header and override any corresponding syntax elements included in the HPS.

In various examples in accordance with this disclosure, HPS RBSP syntax may be specified as per one or both of Syntax Tables 5 and 5a below.

SYNTAX TABLE 5

| header_parameter_set( ) { | | Descriptor |
|---|---|---|
| | header_para_set_id | ue(v) |
| | base_HPS_id | ue(v) |
| | if (baseCommonInfoPresent) { | |

| | |
|---|---|
| common_info_overridden_flag | u(1) |

}
if(!common_info_overridden flag &&multiple_hps_enabled_flag )

| | |
|---|---|
| common_info_present_flag | u(1) |

if (common_info_overridden flag || common_info_present_flag)

common_info_table( )

// above are the info. that is typically shared by all HPSs of a layer of an AU

if (baseRefPicListRelatedInfoPresent&& multiple_hps_enabled_flag) {

| | |
|---|---|
| ref_pic_list_related_info_overridden_flag | u(1) |

}
if (common_info_overridden_flag | | ref_pic_list_related_info_present_flag )

reference_pic_related_info_table( )

// prediction weights

if(!common_info_overridden_flag &&

( ( weighted_pred_flag && slice_type = = P) | |
( weighted_bipred_idc = = 1 && slice_type = = B )) )

{

if (basePredWeightTablePresent && multiple_hps_enabled_flag)

pred_weight_table_overridden_flag

if( ! pred_weight_table_info_overridden_flag &&multiple_hps_enabled_flag )

| | |
|---|---|
| pred_weight_table_present_flag | u(1) |

if (pred_weight_table_info_overridden_flag | | pred_weight_table_present_flag )

pred_weight_table( )

}

//deblocking

if ( baseDeblockingParaTablePresent&&deblocking_filter_control_present_flag )

{

deblocking_para_table_overridden_flag
if(!deblocking_para_table_overridden_flag && multiple_hps_enabled_flag )

| | |
|---|---|
| deblocking_para_table_present_flag | u(1) |

if (deblocking_para_table_present_flag | |

deblocking_para_table_overridden_flag)
deblocking_para_table( )

}

// other info. that may or may not be common but don't need to be put in as a new
category to be predicted.

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |

( slice_adaptive_loop_filter_flag | | slice_sample_adaptive_offset_flag | |

!disable_deblocking_filter_flag ) )

| | |
|---|---|
| slice_loop_filter_across_slices_enabled_flag | u(1) |

}
if(adaptive_loop_filter_enabled_flag )

| | |
|---|---|
| aps_id | ue(v) |

// layer specific information ...

...

}

SYNTAX TABLE 5a

| header_parameter_set( ) { | | Descriptor |
|---|---|---|
| | header_para_set_id | ue(v) |
| | base_hps_id | ue(v) |
| | if( baseCommonInfoPresent ) | |

| | |
|---|---|
| common_info_overridden_flag | u(1) |

if( !common_info_overridden_flag &&multiple_hps_enabled_flag )

| | |
|---|---|
| common_info_present_flag | u(1) |

if( common_info_overridden_flag || common_info_present_flag )

common_info_table(1 )

// above are the info. that is typically shared by all HPSs of a layer of an AU

if(baseRefPicListRelatedInfoPresent&& multiple_hps_enabled_flag)

| | |
|---|---|
| ref_pic_list_related_info_overridden_flag | u(1) |

if( common_info_overridden_flag | | ref_pic_list_related_info_present_flag )

reference_pic_related_info_table( )

// prediction weights

if( !common_info_overridden_flag &&

( ( weighted_pred_flag && slice_type = = P) | |
( weighted_bipred_idc = = 1 && slice_type = = B ) ) )

{

if( basePredWeightTablePresent && multiple_hps_enabled_flag )

pred_weight_table_overridden_flag

if( ! pred_weight_table_info_overridden_flag &&multiple_hps_enabled_flag )

| | |
|---|---|
| pred_weight_table_present_flag | u(1) |

if (pred_weight_table_info_overridden_flag | | pred_weight_table_present_flag )

pred_weight_table( )

}

//deblocking

if( baseDeblockingParaTablePresent&&deblocking_filter_control_present_flag ) {

deblocking_para_table_overridden_flag
if(!deblocking_para_table_overridden_flag && multiple_hps_enabled_flag )

| | |
|---|---|
| deblocking_para_table_present_flag | u(1) |

if (deblocking_para_table_present_flag | |

deblocking_para_table_overridden_flag)
deblocking_para_table( )

}

// other info. that may or may not be common but don't need to be put in as a new
category to be predicted.

if( cabac_init_present_flag && slice_type != I )

| | |
|---|---|
| cabac_init_flag | u(1) |

| | |
|---|---|
| slice_qp_delta | se(v) |
| if( seq_loop_filter_across_slices_enabled_flag && | |

( slice_adaptive_loop_filter_flag | | slice_sample_adaptive_offset_flag | |

!disable_deblocking_filter_flag ) )

| | |
|---|---|
| slice_loop_filter_across_slices_enabled_flag | u(1) |

}
if(adaptive_loop_filter_enabled_flag )

| | |
|---|---|
| aps_id | ue(v) |

// layer specific information ...

...

}

Semantics for HPS RBSP syntax specified in Syntax Tables 5 and 5a may be as follows. Video decoder 30 may use the “base_hps_id” to identify the HPS ID of a lower layer, which video decoder 30 may, in turn, reuse (partially or in entirety) to derive a current HPS. Video decoder 30 may derive the value of the “baseCommonInfoPresent” syntax element to be 1, if video decoder 30 determines either that the common_info_table( ) is present in the base HPS, or reused for the base HPS. Video decoder 30 may derive the value of the “baseRefPicListRelatedInfoPresent” syntax element to be 1, if video decoder 30 determines either that the reference_pic_related_info_table( ) is present in the base HPS, or reused for the base HPS. Additionally, video decoder 30 may derive the value of the “basePredWeightTablePresent” syntax element to be 1, if video decoder 30 determines either that the pred_weight_table( ) is present in the base HPS, or that the pred_weight_table( ) is reused for the base HPS.

Video decoder 30 may derive the value of the “baseDeblockingParaTablePresent” to be 1, if video decoder 30 determines either that the deblocking_para_table( ) is present in the base HPS, or is reused for the base HPS. Additionally, if video decoder 30 derives the value of the “common_info_overridden_flag” syntax element to be equal to 1, then this syntax element may indicate that common_info_table( ) is present in the current HPS. More specifically, in this scenario, video decoder 30 may use the common_info_table( ) to override any information reused from the reference HPS. On the other hand, if video decoder 30 determines that the value of the common_info_overridden_flag syntax element is equal to 0, then this syntax element may indicate that the common_info_table( ) is not present in the current HPS, when the reference HPS includes the same portion of information.

If video decoder 30 determines that the value of the “ref_pic_list_related_info_overridden_flag” syntax element is equal to 1, this syntax element may indicate that the reference_pic_related_info_table( ) is included in the current HPS. More specifically, in this scenario, video decoder 30 may use one or more values of the reference_pic_related_info_table( ) to override any corresponding data reused from the reference HPS. Conversely, if video decoder 30 determines that the value of the ref_pic_list_related_info_overridden_flag syntax element is equal to 0, then this syntax element may indicate that the reference_pic_related_info_table( ) is not present in the current HPS, when the reference HPS includes the corresponding portion(s) of information. If video decoder 30 determines that the value of the “pred_weight_table_overridden_flag” syntax element is equal to 1, this syntax element may indicate that the pred_weight_table( ) is present in the current HPS. In this scenario, video decoder 30 may use the pred_weight_table( ) to override any corresponding data reused from the reference HPS. Conversely, if video decoder 30 determines that the value of the pred_weight_table_overridden_flag is equal to 0, this syntax element may indicate that the pred_weight_table( ) is not present in the current HPS, when the reference HPS includes the corresponding portion(s) of data.

Video decoder 30 may determine that the value of the “deblocking_para_table_overridden_flag” syntax element is equal to 1, indicating that the deblocking_para_table( ) is present in the current HPS. In this scenario, video decoder 30 may use data of the deblocking_para_table( ) to override corresponding data reused from the reference HPS. On the other hand, if video decoder 30 determines that the deblocking_para_table_overridden_flag is set to a value equal to 0, this syntax element may indicate that the deblocking_para_table( ) is not present in the current HPS, when the reference HPS includes the corresponding portion(s) of data.

In some scenarios in accordance with this disclosure, video encoder 20 may signal, and video decoder 30 may receive, syntax elements in the slice header, in a similar fashion as described above with respect to HPSs. For instance, video decoder 30 may use the value of a flag in a slice header to determine whether a group of syntax elements is inherited from a specific slice header (e.g. the first slice header) of the view component of the base view in the same AU. Examples of slice header syntax elements for base views are illustrated in syntax table 6, and slice header syntax elements for non-base views are illustrated in syntax table 6a below. Changes from the current HEVC working draft, in accordance with this disclosure, are denoted by underlining.

SYNTAX TABLE 6

| slice_segment_header( ) { | | Descriptor |
|---|---|---|
| | first_slice_segment_in_pic_flag | u(1) |
| | if( RapPicFlag ) | |

| | |
|---|---|
| no_output_of_prior_pics_flag | u(1) |

| | |
|---|---|
| slice_pic_parameter_set_id | ue(v) |
| if( !first_slice_segment_in_pic_flag ) { | |

if(dependent_slice_segments_enabled_flag )

| | |
|---|---|
| dependent_slice_segment_flag | u(1) |

| | |
|---|---|
| slice_segment_address | u(v) |

}
if( !dependent_slice_segment_flag ) {

| | |
|---|---|
| discardable_flag | u(1) |
| for ( i = 0; i < num_extra_slice_header bits − 1; i++ ) | |

| | |
|---|---|
| slice_reserved_undetermined_flag[ i ] | u(1) |

| | |
|---|---|
| slice_type | ue(v) |
| if( output_flag_present_flag ) | |

| | |
|---|---|
| pic_output_flag | u(1) |

if( separate_colour_plane_flag = = 1 )

| | |
|---|---|
| colour_plane_id | u(2) |

if( !IdrPicFlag ) {

| | |
|---|---|
| pic_order_cnt_lsb | u(v) |
| short_term_ref_pic_set_sps_flag | u(1) |
| if( !short_term_ref_pic_set_sps_flag ) | |

short_term_ref_pic_set( num_short_term_ref_pic_sets )

else if( num_short_term_ref_pic_sets > 1 )

| | |
|---|---|
| short_term_ref_pic_set_idx | u(v) |

if( long_term_ref_pics_present_flag ) {

if( num_long_term_ref_pics_sps > 0 )

| | |
|---|---|
| num_long_term_sps | ue(v) |

| | |
|---|---|
| num_long_term_pics | ue(v) |
| for( i = 0; i < num_long_term_sps + num_long_term_pics; i++ ) { | |

if( i < num_long_term_sps && num_long_term_ref_pics_sps

> 1)

| | |
|---|---|
| lt_idx_sps[ i ] | u(v) |

else {

| | |
|---|---|
| poc_lsb_lt[ i ] | u(v) |
| used_by_curr_pic_lt_flag[ i ] | u(1) |

| | |
|---|---|
| } | |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

}

}
if( sps_temporal_mvp_enable_flag )

| | |
|---|---|
| slice_temporal_mvp_enable_flag | u(1) |

}
if( sample_adaptive_offset_enabled_flag ) {

| | |
|---|---|
| slice_sao_luma_flag | u(1) |
| slice_sao_chroma_flag | u(1) |

}
if( slice_type = = P | | slice_type = = B ) {

| | |
|---|---|
| num_ref_idx_active_override_flag | u(1) |
| if( num_ref_idx_active_override_flag ) { | |

| | |
|---|---|
| num_ref_idx_l0_active_minus1 | ue(v) |
| if( slice_type = = B ) | |

| | |
|---|---|
| num_ref_idx_l1_active_minus1 | ue(v) |

}
if( lists_modification_present_flag && NumPocTotalCurr > 1 )

ref_pic_lists_modification( )

if( slice_type = = B )

| | |
|---|---|
| mvd_l1_zero_flag | u(1) |

if( cabac_init_present_flag )

| | |
|---|---|
| cabac_init_flag | u(1) |

if( slice_temporal_mvp_enable_flag ) {

if( slice_type = = B )

| | |
|---|---|
| collocated_from_l0_flag | u(1) |

if( ( collocated_from_l0_flag &&

num_ref_idx_l0_active_minus1 > 0 )

| | ( !collocated_from_l0_flag &&

num_ref_idx_l1_active_minus1 > 0 ) )

| | |
|---|---|
| collocated_ref_idx | ue(v) |

}
if( ( weighted_pred_flag && slice_type = = P) | |

( weighted_bipred_flag && slice_type = = B ) )

pred_weight_table( )

| | |
|---|---|
| five_minus_max_num_merge_cand | ue(v) |

| | |
|---|---|
| } | |
| slice_qp_delta | se(v) |
| if( pps_slice_chroma_qp_offsets_present_flag ) { | |

| | |
|---|---|
| slice_cb_qp_offset | se(v) |
| slice_cr_qp_offset | se(v) |

}
if( deblocking_filter_control_present_flag ) {

if( deblocking_filter_override_enabled_flag )

| | |
|---|---|
| deblocking_filter_override_flag | u(1) |

if( deblocking_filter_override_flag ) {

| | |
|---|---|
| slice_disable_deblocking_filter_flag | u(1) |
| if( !slice_disable_deblocking_filter_flag ) { | |

| | |
|---|---|
| slice_beta_offset_div2 | se(v) |
| slice_tc_offset_div2 | se(v) |

}

}

}
if( loop_filter_across_slices_enabled_flag &&

( slice_sao luma_flag | | slice_sao_chroma_flag | |

!slice_disable_deblocking_filter_flag ) )

| | |
|---|---|
| slice_loop_filter_across_slices_enabled_flag | u(1) |

}
if( tiles enabled_flag | | entropy_coding_sync_enabled_flag ) {

| | |
|---|---|
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_segment_header_extension_present_flag ) {

| | |
|---|---|
| slice_segment_header_extension_length | ue(v) |
| for( i = 0; i < slice_segment_header_extension_length; i++) | |
| slice_segment_header_extension_data_byte[ i ] | u(8) |

}
byte_alignment( )

}

SYNTAX TABLE 6a

| | | De- |
|---|---|---|
| | | scrip- |
| slice_segment_header( ) { | | tor |
| | first_slice_segment_in_pic_flag | u(1) |
| | common_info_pred_flag | u(1) |
| | if( !common_info_pred_flag ) { | |

if( RapPicFlag )

| | |
|---|---|
| no_output_of_prior_pics_flag | u(1) |

| | |
|---|---|
| slice_pic_parameter_set_id | ue(v) |

}
if( !first_slice_segment_in_pic_flag ) {

if(dependent_slice_segments_enabled_flag )

| | |
|---|---|
| dependent_slice_segment_flag | u(1) |

| | |
|---|---|
| slice_segment_address | u(v) |

}
if( !dependent_slice_segment_flag ) {

| | |
|---|---|
| discardable_flag | u(1) |
| for ( i = 0; i < num_extra_slice_header_bits− | |
| 1; i++ ) | |

| | |
|---|---|
| slice_reserved_undetermined_flag[ i ] | u(1) |

| | |
|---|---|
| slice_type | ue(v) |
| if( separate_colour_plane_flag = = 1 ) | |

| | |
|---|---|
| colour_plane_id | u(2) |

if( cabac_init_present_flag )

| | |
|---|---|
| cabac_init_flag | u(1) |

if( !common_info_pred_flag )

common_info_table( )

| | |
|---|---|
| ref_pic_list_related_info_pred_flag | u(1) |
| if( !ref_pic_list_related_info_pred_flag ) | |

ref_pic_list_related_info_table( )

if( ( weighted_pred_flag && slice_type = = P) | |

( weighted_bipred_flag && slice_type = = B ) ) {

| | |
|---|---|
| pred_weight_pred_flag | u(1) |
| if( !pred_weight_pred_flag ) | |

pred_weight_table( )

| | |
|---|---|
| } | |
| deblocking_para_table_pred_flag | u(1) |
| if( !deblocking_para_table_pred_flag ) | |

deblocking_para_table( )

if( sample_adaptive_offset_enabled_flag ) {

| | |
|---|---|
| slice_sao_luma_flag | u(1) |
| slice_sao_chroma_flag | u(1) |

| | |
|---|---|
| } | |
| slice_qp_delta | se(v) |
| if( pps_slice_chroma_qp_offsets_present_flag ) { | |

| | |
|---|---|
| slice_cb_qp_offset | se(v) |
| slice_cr_qp_offset | se(v) |

}
if( loop_filter_across_slices_enabled_flag &&

( slice_sao_luma_flag | | slice_sao_chroma_flag | |

!slice_disable_deblocking_filter_flag ) )

| | |
|---|---|
| slice_loop_filter_across_slices_enabled_flag | u(1) |

}
if( tiles enabled_flag | |
entropy_coding_sync_enabled_flag ) {

| | |
|---|---|
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_segment_header_extension_present_flag ) {

| | |
|---|---|
| slice_segment_header_extension_length | ue(v) |
| for( i = 0; i < | |
| slice_segment_header_extension_length; i++) | |

| | |
|---|---|
| slice_segment_header_extension_data_byte[ i ] | u(8) |

}
byte_alignment( )

}

Semantics corresponding to the slice header syntax elements of syntax tables 6 and 6a may be defined as follows. If video decoder 30 determines that the “discardable_flag” has a value equal to 1, this syntax element may specify that video decoder 30 does not require a view component in order to decode any other view components with layer_id greater than the layer_id of the current view component, whether directly (e.g., through inter-view prediction by view components in the current AU), or indirectly (e.g., through inter prediction and inter-layer prediction associated with view components in other AUs). Conversely, if video decoder 30 determines that the discardable_flag has a value equal to 0, this syntax element may specify that video decoder 30 requires the view component in order to decode at least one other view component with layer_id greater than the layer_id of the current view component, whether directly or indirectly.

If video decoder 30 determines that the value of the “common_info_pred_flag” syntax element is equal to 0, this syntax element may indicate that the syntax elements in the common_info_table( ) the “no_output_prior_pics” flag, and the “slice_pic_parameter_set_id” are not inherited from any slice header of a base view, and are explicitly present in the slice header. Conversely, if video decoder 30 determines that the common_info_pred_flag is set to a value equal to 1, this syntax element may indicate that syntax elements in the common_info_table( ) the no_output_prior_pics_flag, and the slice_pic_parameter_set_id are the same as in the first slice of the base view of the same AU.

If video decoder 30 determines that the value of the “ref_pic_list_related_info_pred_flag” is equal to 0, this syntax element may indicate that the syntax elements in the ref_pic_list_related_info_table( ) are not inherited from any slice header of a base view, and more specifically, that the syntax elements in the are explicitly present ref_pic_list_related_info_table( ) in the slice header. On the other hand, if video decoder 30 determines that the “ref_pic_list_related_info_pred_flag” is set to a value equal to 1, this syntax element may indicate that one or more syntax elements in the ref_pic_list_related_info_table( ) are the same as in the first slice of the base view of the same AU. If video decoder 30 determines that the value of the “pred_weight_pred_flag” syntax element is equal to 0, this syntax element may indicate that the syntax elements in the pred_weight_table( ) are not inherited from any slice header of a base view, and that the syntax elements in the pred_weight_table( ) are explicitly included in the slice header. On the other hand, if video decoder 30 determines that the value of the pred_weight_pred_flag is equal to 1, this syntax element may indicate that one or more syntax elements in the pred_weight_table( ) are the same as in the first slice of the base view of the same AU.

If video decoder 30 determines that the value of the “deblocking_para_table_pred_flag” syntax element is equal to 0, this syntax element may indicate that the syntax elements in the deblocking_para_table( ) are not inherited from any slice header of a base view, and, more specifically, that the syntax elements in the deblocking_para_table( ) are explicitly present in the slice header. Conversely, if video decoder 30 determines that the deblocking_para_table_pred_flag is set to a value equal to 1, this syntax element may indicate that one or more syntax elements in the deblocking_para_table( ) are the same as in the first slice of the base view of the same AU.

Syntax table 7 below illustrates common information in accordance with syntax tables 6 and 6a described above, with changes denoted by underlining

SYNTAX TABLE 7
common_info_table( ) {

if( output_flag_present_flag )

| | |
|---|---|
| pic_output_flag | u(1) |

if( !IdrPicFlag ) {

| | |
|---|---|
| pic_order_cnt_lsb | u(v) |
| short_term_ref_pic_set_sps_flag | u(1) |
| if( !short_term_ref_pic_set_sps_flag ) | |

short_term_ref_pic_set(
num_short_term_ref_pic_sets )

else if( num_short_term_ref_pic_sets > 1 )

| | |
|---|---|
| short_term_ref_pic_set_idx | u(v) |

if( long_term_ref_pics_present_flag ) {

if( num_long_term_ref_pics_sps > 0 )

| | |
|---|---|
| num_long_term_sps | ue(v) |

| | |
|---|---|
| num_long_term_pics | ue(v) |
| for( i = 0; i < num_long_term_sps + | |
| num_long_term_pics; i++ ) { | |

if( i < num_long_term_sps &&

num_long_term_ref_pics_sps > 1)

| | |
|---|---|
| lt_idx_sps[ i ] | u(v) |

else {

| | |
|---|---|
| poc_lsb_lt[ i ] | u(v) |
| used_by_curr_pic_lt_flag[ i ] | u(1) |

| | |
|---|---|
| } | |
| delta_poc_msb_present_flag[ i ] | u(1) |
| if( delta_poc_msb_present_flag[ i ] ) | |

| | |
|---|---|
| delta_poc_msb_cycle_lt[ i ] | ue(v) |

}

}

}

}

The existing semantics of each syntax element (‘x’) in syntax table 7 (also referred to herein as common_info_table( ) may apply with the following addition: if the value of the “common_info_pred_flag” is zero, video decoder 30 may infer the value of x to be equal to the value of the syntax element x in the first slice header of the base view of the same AU.

An example of reference picture list information, in accordance with syntax table 7, is illustrated in syntax table 8 below, with changes denoted by underlining.

SYNTAX TABLE 8
ref_pic_list_related_info_table( ) {

if( !IdrFlag )

if( sps_temporal_mvp_enable_flag )

| | |
|---|---|
| slice_temporal_mvp_enable_flag | u(1) |

if( slice_type = = P | | slice_type = = B ) {

| | |
|---|---|
| num_ref_idx_active_override_flag | u(1) |
| if( num_ref_idx_active_override_flag ) { | |

| | |
|---|---|
| num_ref_idx_l0_active_minus1 | ue(v) |
| if( slice_type = = B ) | |

| | |
|---|---|
| num_ref_idx_l1_active_minus1 | ue(v) |

}
if( lists_modification_present_flag &&
NumPocTotalCurr > 1 )

ref_pic_lists_modification( )

if( slice_type = = B )

| | |
|---|---|
| mvd_l1_zero_flag | u(1) |

if( slice_temporal_mvp_enable_flag ) {

if( slice_type = = B )

| | |
|---|---|
| collocated_from_l0_flag | u(1) |

if( ( collocated_from_l0_flag &&

num_ref_idx_l0_active_minus1 > 0)

| | ( !collocated_from_l0_flag &&

num_ref_idx_l1_active_minus1 > 0 ) )

| | |
|---|---|
| collocated_ref_idx | ue(v) |

| | |
|---|---|
| } | |
| five_minus_max_num_merge_cand | ue(v) |

}

}

The existing semantics of each syntax element (‘x’) in syntax table 8, or “ref_pic_list_related_info_table( )” may apply with the following addition: if video decoder 30 determines that the value of the “ref_pic_list_related_info_pred_flag” syntax element is zero, video decoder 30 may infer the value of x to be equal to the value of the syntax element x in the first slice header of the base view of same AU.

Syntax table 9 below specifies examples of deblocking parameters in accordance with the semantics of syntax table 8.

SYNTAX TABLE 9
deblocking_para_table( ) {

if( deblocking_filter_control_present_flag ) {

if( deblocking_filter_override_enabled_flag )

| | |
|---|---|
| deblocking_filter_override_flag | u(1) |

if( deblocking_filter_override_flag ) {

| | | |
|---|---|---|
| s | slice_disable_deblocking_filter_flag | u(1) |

if( !slice_disable_deblocking_filter_flag ) {

| | |
|---|---|
| slice_beta_offset_div2 | se(v) |
| slice_tc_offset_div2 | se(v) |

}

}

}

}

In examples, the existing semantics of each syntax element (‘x’) in syntax table 9, or deblocking_para_table( ) above, applies with the following addition: if video decoder 30 determines that the value of the “deblocking_para_pred_flag” is zero, the value of x is inferred to be equal to the value of the corresponding syntax element x in the first slice header of the base view of the same AU. According to some aspects of this disclosure, the existing semantics of each syntax element x in pred_weight_table( ) applies with the following addition: if video decoder 30 determines that the value of the “pred_weight_pred_flag” is zero, video decoder 30 may infer the value of x to be equal to the value of the corresponding syntax element x in the first slice header of the base view of the same AU.

In some instances, video encoder 20 and/or video decoder 30 may replace the syntax elements common_info_pred_flag, ref_pic_list_related_info_pred_flag, pred_weight_pred_flag and deblocking_para_pred_flag with common_info_pred_address_plus1, ref_pic_list_related_info_pred_address_plus1, pred_weight_pred_address_plus1 and deblocking_para_pred_address_plus1, respectively. In these examples, the new syntax elements point to the slice segment headers of the base view from which the original syntax elements in the respective tables are inherited. More specifically, if video decoder 30 determines that the common_info_pred_address_plus1 syntax element is set to a value equal to zero, this syntax element may indicate that the syntax elements in the common_info_table( ) are not inherited from any slice header of a base view, and, more specifically, that the syntax elements in the common_info_table( ) are explicitly included in the slice header. On the other hand, if video decoder 30 determines that the common_info_pred_address_plus1 syntax element is set to any non-zero value, then video decoder 30 may determine that the common_info_pred_address_plus1 syntax element, minus 1, indicates the address of the slice segment in the base view associated with a slice segment header from which video decoder 30 derives the respective values of the syntax elements in the common_info_table( ).

Video decoder 30 may determine, if the “ref_pic_list_related_info_pred_address_plus1” syntax element is set to a value equal to zero, that this syntax element indicates that the syntax elements in the ref_pic_list_related_info_table( ) are not inherited from any slice header of a base view, and rather, that the syntax elements of the ref_pic_list_related_info_table( ) are explicitly included in the slice header. On the other hand, if video decoder 30 determines that the “ref_pic_list_related_info_pred_address_plus1” syntax element is set to any non-zero values, then video decoder may determine that the “ref_pic_list_related_info_pred_address_plus1” syntax element, minus 1 indicates the address of the slice segment in the base view of the AU, that is associated with a slice segment header from which video decoder 30 derives the values of the various syntax elements in the ref_pic_list_related_info_table( ).

In examples where video decoder 30 determines that the value of the “pred_weight_pred_address_plus1” syntax element is equal to zero, video decoder 30 may determine that this syntax element indicates that the syntax elements in the pred_weight_table( ) are not inherited from any slice header of a base view, and that rather, these syntax elements are explicitly included in the slice header. On the other hand, if video decoder 30 determines that the pred_weight_pred_address_plus1 syntax element is set to any non-zero value, then video decoder may determine that the value of pred_weight_pred_address_plus1, minus 1, indicates the address of the slice segment in the base view associated with a slice segment header that video decoder 30 uses to derive values of the syntax elements in the pred_weight_table( ).

If video decoder 30 detects that the value of the “deblocking_para_table_pred_address_plus1” syntax element is equal to zero, then video decoder 30 may determine that this syntax element indicates that the syntax elements in the deblocking_para_table( ) are not inherited from any slice header of a base view, but rather, that these syntax elements are explicitly present in the slice header. However, if video decoder 30 detects that deblocking_para_table_pred_address_plus1 is set to any non-zero values, video decoder 30 may determine that the value of the deblocking_para_table_pred_address_plus1 syntax element, minus 1, indicates the address of the slice segment in the base view associated with a slice segment header that video decoder 30 uses to derive the values of the various syntax elements in the deblocking_para_table( ).

In some instances, video decoder 30 may detect that one or more syntax elements of the common_info_table( ) ref_pic_list_related_info_table( ) or deblocking_para_table( ) are explicitly present outside of the respective table, and thus, such syntax elements are not inherited. In some instances, video decoder 30 may not inherit the slice_pic_parameter_set_id syntax element, but rather, this syntax element may always be present in the slice header. In some instances, the slice_pic_parameter_set_id syntax element may be present as part of the ref_pic_list_related_info_table( ) and thus, video encoder 20 and/or video decoder 30 may inherit the slice_pic_parameter_set_id syntax element.

Video decoder 30 may, in some instances, detect a flag may be present in the video parameter set (VPS) extension, the flag indicating whether slice header inheritance is enabled for all operation points, or otherwise, enabled for each given operation point, or for a given layer. In some examples, video encoder 20 may signal a syntax element in the VPS, to indicate to video decoder 30, from which slice header in the base view to inherit syntax elements in the common_info_table( ) ref_pic_list_related_info_table( ) pred_weight_table( ) and deblocking_para_table( ).

In some examples, video encoder 20 may signal a syntax element in a slice header to indicate, to video decoder 30, whether to inherit portions of the slice header in the current view from the base view, or from the first dependent view as defined in the VPS extension. In some examples, video encoder 20 may signal, for each non-base view, a syntax element in the VPS to assist video decoder 30 to determine from which view to inherit the syntax elements in the slice segment header.

In some examples, video encoder 20 may signal the discardable_flag and the loop of slice_reserved_undetermined_flag[i] in the slice header. In other words, video encoder 20 may signal these syntax elements, without the signaling being conditioned on the value of the dependent_slice_segment_flag being equal to 1, and before any entropy coded (i.e., ue(v)-coded) syntax elements (e.g., immediately after the syntax element first_slice_segment_in_pic_flag). Additionally, according to some such examples, video encoder 20 may move the syntax element num_extra_slice_header_bits from the PPS to the VPS, and reuse/repeat the corresponding value in the SPS.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, various computer-readable storage devices, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding encoded video data, the method comprising:
determining a header parameter set that includes one or more syntax elements specified individually by each of one or more slice headers, the header parameter set being associated with a header parameter set identifier (HPS ID); and
determining one or more slice headers that reference the header parameter set to inherit at least one of the syntax elements included in the header parameter set,
wherein the slice headers are each associated with a slice of the encoded video data, and
wherein the slice headers each reference the header parameter set using the HPS ID.

2. The method of claim 1,
wherein determining the header parameter set comprises determining the header parameter set for an access unit that includes one or more slice headers, and
wherein the header parameter set for the access unit includes the one or more syntax elements for any slices associated with the access unit but not for any slices associated with a different access unit.

3. The method of claim 1,
wherein determining the header parameter set comprises determining the header parameter set for an access unit different than an access unit that includes the header parameter set and the one or more slice headers, and
wherein the header parameter set determined for the access unit includes the one or more syntax elements for any slices associated with one or both of the access unit different than the access unit that includes the header parameter set and the access unit that includes the header parameter set.

4. The method of claim 1, wherein determining the header parameter set comprises determining the header parameter set for a first layer of the encoded video data.

5. The method of claim 4, wherein determining the header parameter set for a first layer of the encoded video data comprises determining the header parameter set for a first layer of the encoded video data that inherits syntax elements specified in a header parameter set for a second layer of the encoded video data.

6. The method of claim 5, wherein the second layer is a lower layer than the first layer.

7. The method of claim 5, wherein determining the one or more slice headers comprises determining a slice header that references at least one of the syntax elements included within the header parameter set for the first layer and at least one syntax element included within the header parameter set for the second layer.

8. The method of claim 5, wherein the first layer of the encoded video data provides video data that augments the second layer of the encoded video data to enable higher resolutions of the encoded video data.

9. The method of claim 5, wherein the first layer of the encoded video data provides a different view than a view provided by the second layer of the encoded video data.

10. A method of encoding video data, the method comprising:
generating a header parameter set that includes one or more syntax elements specified individually by each of one or more slice headers, the header parameter set being associated with a header parameter set identifier (HPS ID); and
generating one or more slice headers to reference the header parameter set to inherit at least one of the syntax elements included in the header parameter set,
wherein the slice headers are each associated with a slice of the encoded video data, and
wherein the slice headers each reference the header parameter set using the HPS ID.

11. The method of claim 10, wherein generating the header parameter set comprises generating the header parameter set for an access unit that includes the one or more slice headers, and
wherein the header parameter set generated for the access unit includes the one or more syntax elements for any slices associated with the access unit but not for any slices associated with a different access unit.

12. The method of claim 10,
wherein generating the header parameter set comprises generating the header parameter set for an access unit different than an access unit that includes the header parameter set and the one or more slice headers, and
wherein the header parameter set generated for the access unit includes the one or more syntax elements for any slices associated with one or both of the access unit different than the access unit that includes the header parameter set and the access unit that includes the header parameter set.

13. The method of claim 10, wherein generating the header parameter set comprises generating the header parameter set for a first layer of the video data.

14. The method of claim 13, wherein generating the header parameter set for a first layer of the video data comprises generating the header parameter set for a first layer of the video data that inherits syntax elements specified in a header parameter set for a second layer of the video data.

15. The method of claim 14, wherein the second layer is a lower layer than the first layer.

16. The method of claim 14, wherein generating the one or more slice headers comprises generating a slice header that references at least one of the syntax elements included within the header parameter set for the first layer and at least one syntax element included within the header parameter set for the second layer.

17. The method of claim 14, wherein the first layer of the video data provides video data that augments the second layer of the video data to enable higher resolutions of the video data.

18. The method of claim 14, wherein the first layer of the video data provides a different view than a view provided by the second layer of the video data.

19. A device for coding video data, the device comprising a video coder configured to:
determine a header parameter set that includes one or more syntax elements specified individually by each of one or more slice headers, the header parameter set being associated with a header parameter set identifier (HPS ID); and
determine one or more slice headers that reference the header parameter set to inherit at least one of the syntax elements included in the header parameter set,
wherein the slice headers are each associated with a slice of encoded video data, and
wherein the slice headers each reference the header parameter set using the HPS ID.

20. The device of claim 19, wherein the device comprises at least one of:
an integrated circuit;
a microprocessor; and
a communication device that comprises the video coder.

21. The device of claim 19,
wherein, to determine the header parameter set, the video coder is configured to determine the header parameter set for an access unit that includes one or more slice headers, and
wherein the header parameter set for the access unit includes the one or more syntax elements for any slices associated with the access unit but not for any slices associated with a different access unit.

22. The device of claim 19,
wherein, to determine the header parameter set, the video coder is configured to determine the header parameter set for an access unit different than an access unit that includes the header parameter set and the one or more slice headers, and
wherein the header parameter set determined for the access unit includes the one or more syntax elements for any slices associated with one or both of the access unit different than the access unit that includes the header parameter set and the access unit that includes the header parameter set.

23. The device of claim 19, wherein, to determine the header parameter set, the video coder is configured to determine the header parameter set for a first layer of the encoded video data.

24. The device of claim 23, wherein, to determine the header parameter set for a first layer of the encoded video data, the video coder is configured to determine the header parameter set for a first layer of the encoded video data that inherits syntax elements specified in a header parameter set for a second layer of the encoded video data.

25. The device of claim 24, wherein the second layer is a lower layer than the first layer.

26. The device of claim 24, wherein, to determine the one or more slice headers, the video coder is configured to determine a slice header that references at least one of the syntax elements included within the header parameter set for the first layer and at least one syntax element included within the header parameter set for the second layer.

27. The device of claim 24, wherein the first layer of the encoded video data provides encoded video data that augments the second layer of the encoded video data to enable higher resolutions of the encoded video data.

28. The device of claim 24, wherein the first layer of the encoded video data provides a different view than a view provided by the second layer of the encoded video data.

29. The device of claim 19, wherein the video coder comprises a video decoder configured to entropy decode the encoded video data.

30. The device of claim 19, wherein the video coder comprises a video encoder configured to entropy encode video data to generate the encoded video data.

31. A computer-readable storage medium having stored thereon instructions that, when executed, cause a programmable processor of a computing device to:
determine a header parameter set that includes one or more syntax elements specified individually by each of one or more slice headers, the header parameter set being associated with a header parameter set identifier (HPS ID); and
determine one or more slice headers that reference the header parameter set to inherit at least one of the syntax elements included in the header parameter set,
wherein the slice headers are each associated with a slice of encoded video data, and
wherein the slice headers each reference the header parameter set using the HPS ID.

32. A device for coding video data, the device comprising:
means for determining a header parameter set that includes one or more syntax elements specified individually by each of one or more slice headers, the header parameter set being associated with a header parameter set identifier (HPS ID); and
means for determining one or more slice headers that reference the header parameter set to inherit at least one of the syntax elements included in the header parameter set,
wherein the slice headers are each associated with a slice of the encoded video data, and
wherein the slice headers each reference the header parameter set using the HPS ID.
